(19) United States
(12) Patent Application Publication
(10) Pub. No.: US 2026/0304259 A1
(43) Pub. Date: Oct. 1, 2026

(54) Managing LTM Configurations in Relation to a Layer-3 (L3) Mobility Procedure

(71) Applicant: Telefonaktiebolaget LM Ericsson (publ), Stockholm (SE)

(72) Inventors: Pontus Wallentin, Linköping (SE); Icaro Leonardo Da Silva, Solna (SE); Antonino Orsino, Kirkkonummi (FI); Ioanna Pappa, Stockholm (SE)

(21) Appl. No.: 19/479,562

(22) PCT Filed: May 7, 2024
(86) PCT No.: PCT/SE2024/050431

§ 371 Date: Oct. 28, 2025

Related U.S. Application Data
(60) Provisional application No. 63/501,203, filed on May 10, 2023.

(51) Int. Cl. H04W 36/04; H04W 36/00; H04W 36/36

(52) U.S. Cl. CPC H04W 36/04; H04W 36/0055; H04W 36/362

(57) ABSTRACT

Embodiments include methods for a user equipment (UE) configured to perform a layer-3 (L3) mobility procedure in a radio access network (RAN). Such methods include receiving, via a source cell in the RAN, a configuration for a layer-1 or layer-2 triggered inter-cell mobility (LTM) procedure in the RAN. Such methods include managing the LTM configuration during preparation for or execution of an L3 mobility procedure to a target cell in the RAN, including one or more of the following management operations: maintaining the LTM configuration, releasing the LTM configuration, modifying the LTM configuration, and adding a second LTM configuration. Other embodiments include complementary methods for RAN nodes configured to serve the source and target cells, as well as UEs and RAN nodes configured to perform such methods.

### TECHNICAL FIELD

The present application relates generally to the field of wireless networks and more specifically to improving mobility of user equipment (UEs) across multiple cells in a wireless network, based on managing a UE's configurations for layer-1 (L1) or layer-2 (L2) triggered inter-cell mobility (LTM) in conjunction with performing a layer-3 (L3) mobility procedure.

### INTRODUCTION

Currently the fifth generation (5G) of cellular systems is being standardized within the Third-Generation Partnership Project (3GPP). 5G is developed for maximum flexibility to support a variety of use cases including enhanced mobile broadband (eMBB), machine type communications (MTC), ultra-reliable low latency communications (URLLC), side-link device-to-device (D2D), and several others. 5G was initially standardized in Release 15 (Rel-15) and continues to evolve in subsequent releases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

Although not shown, in some deployments the 5GC can be replaced by an Evolved Packet Core (EPC), which conventionally has been used together with a Long-Term Evolution (LTE) Evolved UMTS RAN (E-UTRAN). In such deployments, gNBs (e.g., 100, 150) can connect to one or more Mobility Management Entities (MMEs) in EPC 198 via respective S1-C interfaces. Similarly, gNBs can connect to one or more Serving Gateways (SGWs) in EPC via respective NG-U interfaces.

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells. In general, a DL “beam” is a coverage area of a network-transmitted reference signal (RS) that may be measured or monitored by a UE.

NG RAN logical nodes (e.g., gNB 100) may include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each CU and DU can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

FIG. 2 shows an exemplary configuration of NR user plane (UP) and control plane (CP) protocol stacks between a UE (210), a gNB (220), and an AMF (230). Physical (PHY), Medium Access Control (MAC), Radio Link Control (RLC), and Packet Data Convergence Protocol (PDCP) layers between UE and gNB are common to UP and CP. PDCP provides ciphering/deciphering, integrity protection, sequence numbering, reordering, and duplicate detection for both CP and UP, as well as header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (in gNB). PHY provides transport channel services to MAC and handles transfer over the NR radio interface, e.g., via modulation, coding, antenna mapping, and beam forming.

On CP side, the non-access stratum (NAS) layer between UE and AMF handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC_CONNECTED state (e.g., where data transfer can occur). The UE must perform a random-access (RA) procedure to move from RRC_IDLE to RRC_CONNECTED state where the cell serving the UE is known and an RRC context is established for the UE in the serving gNB, so UE and gNB can communicate.

Long-Term Evolution (LTE) Rel-10 introduced support for channel bandwidths larger than 20 MHz, which continues into NR. To remain compatible with legacy UEs from earlier releases (e.g., Rel-8), a wideband LTE Rel-10 carrier appears as multiple component carriers (CCs), each having the structure of a Rel-8 carrier. A Rel-10 UE can receive multiple CCs based on Carrier Aggregation (CA). The CCs can be considered “cells”, such that a UE in CA has one primary cell (PCell) and one or more secondary cells (SCells). These are referred to collectively as a “cell group”. NR also supports CA starting in Rel-15.

As specified in 3GPP document RP-213565, NR Rel-18 includes a Work Item on NR mobility enhancements, including in the technical area of L1/L2 based inter-cell mobility, also referred to as L1/L2 triggered mobility (LTM). When the UE moves between the coverage areas of two cells, a serving cell change needs to be performed at some point. Currently, serving cell change is triggered by layer 3 (L3, e.g., RRC) measurements and involves RRC signaling to change PCell and PSCell (e.g., when dual connectivity is configured), as well as release/add SCells (e.g., when CA is configured).

Currently, all inter-cell mobility involves complete layer 2 (L2) and layer 1 (L1, i.e., PHY) resets, leading to longer latency, increased signaling overhead, and longer interruptions than for intra-cell beam switching. Thus, a goal of Rel-18 L1/L2 mobility enhancements is to facilitate serving cell changes via L1/L2 signaling to address these problems and/or difficulties.

### SUMMARY

According to 3GPP agreements, while a UE is configured with LTM candidate cells, the UE can also execute any L3 handover command sent by the network. 3GPP has also agreed that the RAN will handle any race conditions (or conflicts) between an LTM cell switch procedure and an L3 mobility procedure (e.g., handover). However, it is unclear how a UE's LTM candidate cell configurations are handled during an L3 mobility procedure. Moreover, it is unclear whether an L3 mobility procedure is impacted by any LTM-related procedures other than LTM cell switch.

An object of embodiments of the present disclosure is to address these and related problems, issues, and/or difficulties, thereby facilitating UE L1/L2 mobility between cells in a RAN (e.g., NG-RAN).

Some embodiments of the present disclosure include methods (e.g., procedures) for a UE configured to perform a layer-3 (L3) mobility procedure in a RAN.

These exemplary methods include receiving, via a source cell in the RAN, a configuration for an LTM procedure in the RAN. These exemplary methods also include managing the LTM configuration during preparation for or execution of an L3 mobility procedure to a target cell in the RAN. This includes one or more of the following management operations:
maintaining the LTM configuration;
releasing the LTM configuration;
modifying the LTM configuration; and
adding a second LTM configuration.

In some embodiments, releasing the LTM configuration is performed when the target cell is provided by a different RAN node than the source cell, and maintaining the LTM configuration is performed when the target cell is provided by a same RAN node as the source cell.

In some embodiments, these exemplary methods also include receiving from the RAN an indication of one or more of the management operations to be performed. In such case, managing the LTM configuration is based on the indication. In some of these embodiments, the indication is received in an L3 mobility command, e.g., a handover command.

In some embodiments, the exemplary method also include sending to the RAN (e.g., to source or target RAN node, as appropriate) a confirmation or acknowledgement that the indicated management operations have been performed.

Other embodiments include methods (e.g., procedures) for a RAN node configured to provide a source cell for UE L3 mobility procedures. In general, these exemplary methods are complementary to the exemplary methods for UEs, summarized above.

These exemplary methods can include sending, to a UE via the source cell, a configuration for an LTM procedure in the RAN. These exemplary methods also include releasing at least a portion of the LTM configuration during preparation for or execution of an L3 mobility procedure for the UE to a target cell in the RAN.

In some embodiments, releasing at least a portion of the LTM configuration is performed based on the target cell for the L3 mobility procedure being provided by another RAN node.

In some embodiments, these exemplary methods also include sending to the UE an indication to release at least a portion of the LTM configuration. In some of these embodiments, the indication is sent in an L3 mobility command, e.g., a handover command. In some of these embodiments, these exemplary methods also include receiving from the UE a confirmation or acknowledgement that the indicated management operations have been performed.

In some embodiments, these exemplary methods also include sending, to a target RAN node that provides the target cell, a request to perform the L3 mobility procedure for the UE; and receiving the following from the target RAN node: a configuration for the L3 mobility procedure for the UE, and an indication to release at least a portion of the LTM configuration. In such case, releasing least a portion of the LTM configuration is responsive to the indication received.

Other embodiments include methods (e.g., procedures) for a RAN node configured to provide a target cell for UE L3 mobility procedures.

These exemplary methods can include, during preparation for or execution of an L3 mobility procedure for a UE to the target cell, managing a configuration for an LTM procedure for the UE from a source cell in the RAN. This includes one or more of the following management operations:
maintaining the LTM configuration;
releasing the LTM configuration;
modifying the LTM configuration; and
adding a second LTM configuration.

In some embodiments, releasing the LTM configuration is performed when the source cell is provided by another RAN node while maintaining the LTM configuration is performed when the source cell is provided by the RAN node.

In some embodiments, these exemplary methods can also include sending to the UE an indication of one or more corresponding management operations to be performed by the UE on the LTM configuration. For example, the indication can be sent to the UE in an L3 mobility command, e.g., handover command. In some of these embodiments, these exemplary methods also include receiving from the UE a confirmation or acknowledgement that the corresponding management operations have been performed.

In some embodiments, these exemplary methods can also include receiving, from a source RAN node that provides the source cell, a request to perform the L3 mobility procedure for the UE; and sending the following to the source RAN node: a configuration for the L3 mobility procedure for the UE, and an indication to release at least a portion of the LTM configuration.

In various embodiments, the L3 mobility procedure can be any of the following: handover, reconfiguration with sync, conditional handover, conditional reconfiguration, primary SCG cell (PSCell) change, conditional PSCell change, conditional PSCell addition, secondary node (SN) change, SN modification, and master node (MN) change.

Other embodiments include UEs and RAN nodes configured to perform operations corresponding to any of the exemplary methods described herein. Other embodiments also include non-transitory, computer-readable media storing computer-executable instructions that, when executed by processing circuitry, configure such UEs and RAN nodes to perform operations corresponding to any of the exemplary methods described herein.

These and other embodiments described herein may facilitate correct operation of L3 mobility when LTM is also configured for a UE by releasing LTM configurations that are not applicable after an L3 mobility procedure, such as intra-CU LTM configuration(s) that are not applicable after an inter-CU L3 mobility procedure. Embodiments may also facilitate configuration of LTM for a UE during configuration or execution of an L3 mobility procedure, such as a target RAN node providing LTM configuration(s) that are applicable after the UE completes the L3 mobility procedure. Furthermore, embodiments may improve UE mobility in RANs (e.g., NG-RANs) by facilitating interoperability of L3 mobility and LTM.

These and other objects, features, and advantages of the present disclosure will become apparent upon reading the following Detailed Description in view of the Drawings briefly described below.

### BRIEF DESCRIPTION OF THE DRAWINGS

FIG. 1 shows a high-level view of an exemplary 5G network architecture.

FIG. 2 shows an exemplary configuration of NR UP and CP protocol stacks.

FIGS. 3-4 show logical architectures for a gNB arranged in the CU/DU (or split gNB) architecture illustrated by FIG. 1.

FIG. 5 shows a signaling flow for an inter-DU/intra-CU L3 mobility procedure for a UE.

FIG. 6 shows an example RAN in which various embodiments of the present disclosure can be implemented.

FIGS. 7-9 and 10A-B show signaling diagrams for various L3 mobility procedures during which LTM configurations for a UE are managed by various entities, according to various embodiments of the present disclosure.

FIG. 11 shows an exemplary method (e.g., procedure) for a UE, according to various embodiments of the present disclosure.

FIG. 12 shows an exemplary method (e.g., procedure) for a source RAN node, according to various embodiments of the present disclosure.

FIG. 13 shows an exemplary method (e.g., procedure) for a target RAN node, according to various embodiments of the present disclosure.

FIG. 14 shows a communication system according to various embodiments of the present disclosure.

FIG. 15 shows a UE according to various embodiments of the present disclosure.

FIG. 16 shows a network node according to various embodiments of the present disclosure.

FIG. 17 shows host computing system according to various embodiments of the present disclosure.

FIG. 18 is a block diagram of a virtualization environment in which functions implemented by some embodiments of the present disclosure may be virtualized.

FIG. 19 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them.

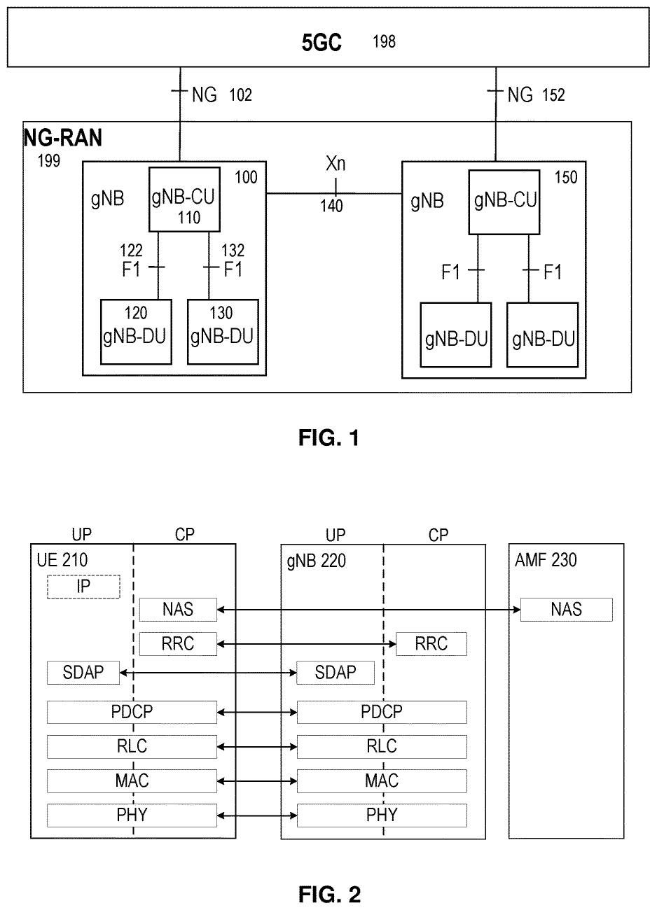

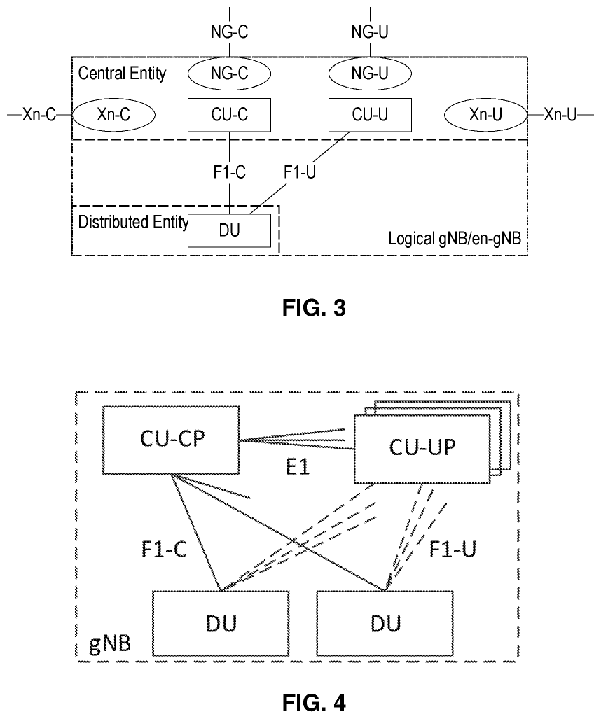

FIG. 3 shows a logical architecture for a gNB arranged in the CU/DU (or split gNB) architecture, such as gNB 100 in FIG. 1. This logical architecture separates the CU into CP and UP functionality, called CU-C and CU-U respectively. Furthermore, each of the NG, Xn, and F1 interfaces is split into a CP interface (e.g., NG-C) and a UP interface (e.g., NG-U). Note that the terms “Central Entity” and “Distributed Entity” in FIG. 3 refer to physical network nodes.

FIG. 4 shows another exemplary gNB logical architecture that includes two gNB-DUs, a gNB-CU-CP, and multiple gNB-CU-UPs. The gNB-CU-CP may be connected to the gNB-DU through the F1-C interface, and the gNB-CU-UP may be connected to the gNB-DU through the F1-U interface and to the gNB-CU-CP through the E1 interface. Each gNB-DU may be connected to only one gNB-CU-CP, and each gNB-CU-UP may be connected to only one gNB-CU-CP. One gNB-DU may be connected to multiple gNB-CU-UPs under the control of the same gNB-CU-CP. Also, one gNB-CU-UP may be connected to multiple DUs under the control of the same gNB-CU-CP. When referring herein to an operation performed by a “CU”, it should be understood that this operation can be performed by any entities within the CU (e.g., CU-CP, gNB-CU-CP) unless stated otherwise.

When a UE moves between the coverage areas of two cells, a serving cell change needs to be performed at some point. Currently, a serving cell change is triggered by layer 3 (L3, e.g., RRC) measurements and involves RRC signaling to change PCell and/or PSCell (e.g., when dual connectivity is configured), as well as release/add SCells (e.g., when CA is configured).

A UE in RRC_CONNECTED state can be configured to perform and report measurements of its serving cell(s) and neighbor cells to its serving RAN node. Upon the reported measurements meeting a certain condition or threshold, the serving RAN node may send a handover command to the UE, indicating a target cell for the handover. In NR, the handover command is an RRCReconfiguration message with a reconfigurationWithSync field. The procedure to perform a handover is sometimes also referred to as “L3 mobility”, as it is controlled by layer 3 (L3, i.e., RRC) and the messages exchanged are part of L3.

These reconfigurations are actually prepared by a target RAN node serving the target cell in advance, upon a request from the UE's serving RAN node. This request is transmitted over the Xn interface in case the serving and target RAN nodes are part of the NG-RAN. The reconfiguration in the handover command takes into account the UE's existing RRC configuration in its current serving cell (also referred to as “source cell”), which are provided in the inter-node request. In some cases, the reconfiguration can be provided as a “delta” to the UE's existing configuration in the source cell, which reduces the size of the handover command.

The reconfiguration provided by the target RAN node contains all information the UE needs to access the target cell, e.g., random access configuration, a new cell radio network temporary identifier (C-RNTI) assigned to the UE in the target cell, and parameters enabling the UE to calculate security keys that it can use when communicating with the target cell (including sending a handover complete message).

In general, UE nobility in RRC_CONNECTED state is network-based as the network has the most information about the current conditions such as cell loading (UEs and/or traffic), available node resources (e.g., processing), available frequencies, etc.

The UE uses the provided C-RNTI starting in message 3 of the random access to the target cell, which enables the target RAN node to identify the UE without context fetching (unless a failure occurs). Also, because the UE receives the target cell random access configuration in the reconfiguration, the UE does not have to acquire this information from SI prior to handover.

In some cases, the random access configuration may include dedicated, contention-free random access (CFRA) resources that the UE uses in message 1 of the random access to the target cell. In this case, the target identifies the UE from the preamble (MSG.1). As such, the dedicated CFRA resources optimize the random access procedure.

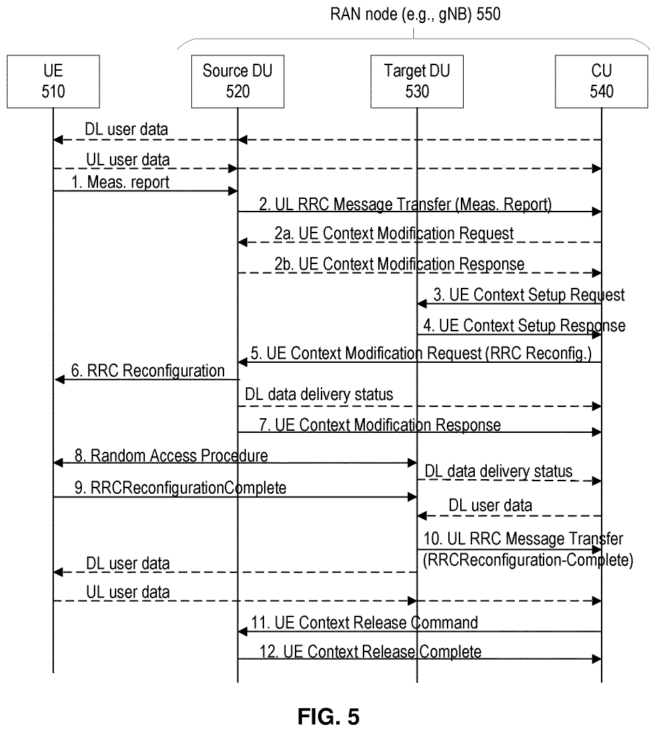

In the CU/DU (or split gNB) architecture, some handovers may involve inter-DU/intra-CU cell changes, where the UE's source and target cells are served by different source and target DUs associated with a single CU. FIG. 5 shows a signaling flow for an inter-DU/intra-CU mobility procedure for a UE (510), where the source DU (520) and target DU (530) are associated with the same CU (540), i.e., part of a single RAN node (550), such as a gNB. Although the operations shown in FIG. 5 are given numerical labels, this is done to facilitate explanation rather than to require or imply any specific operational order, unless expressly stated otherwise.

In operation 1, the UE sends a MeasurementReport message to the source DU. In operation 2, the source DU sends an UL RRC MESSAGE TRANSFER message to the CU to convey the received MeasurementReport message. In operation 2a (which is optional), the CU may send a UE CONTEXT MODIFICATION REQUEST message to the source DU to query the latest configuration. In operation 2b, the source DU responds with a UE CONTEXT MODIFICATION RESPONSE message that includes full configuration information.

In operation 3, the CU sends a UE CONTEXT SETUP REQUEST message to the target DU to create a UE context and setup one or more data bearers. The UE CONTEXT SETUP REQUEST message includes a HandoverPreparationInformation. In operation 4, the target DU responds to the CU with a UE CONTEXT SETUP RESPONSE message.

In operation 5, the CU sends a UE CONTEXT MODIFICATION REQUEST message to the source DU, which includes a generated RRCReconfiguration message and indicates to stop the data transmission for the UE. The source DU also sends a Downlink Data Delivery Status frame to inform the CU about the unsuccessfully transmitted downlink data to the UE. In operation 6, the source DU forwards the received RRCReconfiguration message to the UE. In operation 7, the source DU responds to the CU with the UE CONTEXT MODIFICATION RESPONSE message.

In operation 8, the UE performs a random access procedure is performed at the target DU. The target DU sends a Downlink Data Delivery Status frame to inform the CU. Downlink packets, which may include PDCP PDUs not successfully transmitted in the source DU, are sent from the CU to the target DU. It is up to CU implementation whether to start sending DL User Data to DU before or after reception of the Downlink Data Delivery Status.

In operation 9, the UE responds to the target DU with an RRCReconfigurationComplete message. In operation 10, the target DU sends an UL RRC MESSAGE TRANSFER message to the CU to convey the received RRCReconfigurationComplete message. Downlink packets are sent to the UE. Also, uplink packets are sent from the UE, which are forwarded to the CU through the target DU. In operation 11, the CU sends a UE CONTEXT RELEASE COMMAND message to the source DU. In operation 12, the source DU releases the UE context.

As illustrated in FIG. 5, the execution of the L3 mobility is triggered by the source DU transmitting to the UE an RRCReconfiguration message (operation 6) that was generated by and received from the CU during the preparation phase. This message is based on the CU requesting the target DU to set up a UE context and provide the target cell configuration (e.g., CellGroupConfig) to the CU. Hence, when the target DU receives UE CONTEXT SETUP REQUEST (operation 3), it knows the UE will be arriving in the target cell shortly after it receives the RRCReconfiguration from the CU via the source DU, so that any target cell resources reserved for the incoming UE will be used shortly.

As specified in 3GPP document RP-213565, 3GPP Rel-18 includes a Work Item on NR mobility enhancements, including in the technical area of L1/L2 based inter-cell mobility, also known as L1/L2 triggered mobility (LTM). Conventionally, all inter-cell mobility operations are triggered by L3 RSRP measurements and involve complete layer 2 (L2) and layer 1 (L1, i.e., PHY) resets, leading to longer latency, increased signaling overhead, and longer interruptions than for intra-cell beam switching. Thus, a high-level goal of the Rel-18 L1/L2 mobility enhancements is to facilitate serving cell change via L1/L2 signaling to address these problems and/or difficulties. Some more specific goals include specifying the following:
Configuration and maintenance for multiple candidate cells to allow fast application of configurations for candidate cells;
Dynamic switch mechanism among candidate serving cells (including SpCell and SCell) for the potential applicable scenarios based on L1/L2 signalling;
L1 enhancements for inter-cell beam management, including L1 measurement and reporting, and beam indication;
Timing Advance management; and
CU-DU interface signaling to support L1/L2 mobility, if needed.

These Rel-18 L1/L2 mobility enhancements also must consider the CU/DU (or split gNB) architecture shown in FIGS. 1 and 3-4, including for intra-DU and inter-DU/intra-CU cell changes. In the inter-DU/intra-CU scenario, the candidate cell for LTM is a cell served by a neighbor DU to the (serving or source) DU that currently provides the UE's PCell (or PSCell, for SCG change in DC).

In LTM a UE is pre-configured by its serving RAN with one RRC configuration per LTM candidate cell, sometimes referred to as an “LTM candidate cell configuration”. This configuration may be an RRCReconfiguration message or a portion thereof, such as one or more IEs/fields/parameters (e.g., CellGroupConfig IE). The UE performs measurements on these LTM candidate cells and transmits corresponding measurement reports to the RAN, which triggers the execution of a LTM cell switch procedure by the UE to one of the LTM candidate cells. This triggering is done by transmitting an LTM cell switch command to the UE in lower layer signaling (e.g., MAC control element (CE)). Based on this commend, the UE connects to the associated LTM candidate cell and uses the previously received RRC configuration for this LTM candidate cell.

Since one of the goals of LTM is to reduce the interruption time for UE data transmissions, the UE needs to be ready to communicate with the target cell upon (or shortly after) receiving the L1/L2 signaling for mobility execution from the source cell. For example, the UE must be able to transmit UL data or a scheduling request (SR) to the target cell and/or monitor a DL control channel (e.g., PDCCH) from the target cell. In other words, UE needs to know the cell that it is moving to so it can apply the corresponding configuration, including the correct timing alignment and/or transmission configuration indicator (TCI) state for the cell. Likewise, when the source DU transmits the L1/L2 signaling for mobility execution, the target DU needs to be prepared for scheduling UL and DL transmissions for the UE in the target cell, and for receiving scheduling requests (SR) from the UE.

To further reduce the interruption time and latency during LTM execution, a UE may perform early UL and DL synchronization with an LTM candidate cell before it receives the LTM cell switch command. For early UL synchronization, the UE obtains a Timing Advance (TA) value. This can be triggered by the network transmitting a PDCCH order to the UE in the source cell, followed by the UE transmitting a random access (RA) preamble in the LTM candidate cell indicated by the received PDCCH order. The TA value for the LTM candidate cell may be provided to the UE by the network before LTM execution. For example, the TA value may be included in a RAR (Random Access Response) to the RA preamble, a MAC control element (CE) similar to RAR, or in the LTM cell switch command.

3GPP has agreed to the following principles for LTM in Rel-18:
No security update support in Rel-18 with LTM.
RAN2 to confirm that the CellGroupConfig IE is (mandatory) needed within an LTM candidate cell configuration.
RadioBearerConfig IE can be optionally supported in an LTM candidate configuration.
MeasConfig IE can be optionally supported in an LTM candidate configuration.
OtherConfig IE is not required to be part of the LTM candidate cell configuration.
LTM candidate cell configuration should be designed as “To AddMod/ToRelease” structure.
LTM candidate cell configuration ASN.1 data structure includes at least a CellGroupConfig IE and a configuration ID.
   3GPP has also agreed to the following principles for LTM “delta” configurations in Rel-18:
A UE stores an LTM reference configuration as a separate configuration.
The LTM reference configuration is managed separately.
Use “Model 1”, i.e., one RRCReconfiguration message for each candidate target configuration for an LTM candidate cell.
While configured with LTM candidate cells, the UE can also execute any L3 handover command sent by the network. It should be up to the network to avoid any race condition between LTM execution and L3 handover command, such as avoiding sending LTM cell switch command and L3 handover command in the same transport block (TB).
RRCReconfigurationComplete message is always sent after each LTM execution.
   According to these 3GPP agreements, while a UE is configured with LTM candidate cells, the UE can also execute any L3 handover command sent by the RAN, with the RAN responsible for handling any race conditions (or conflicts) between an LTM cell switch procedure and an L3 mobility procedure (e.g., handover). However, it is unclear how a UE's LTM candidate cell configurations are handled during an L3 mobility procedure. Moreover, it is unclear whether an L3 mobility procedure is impacted by any LTM-related procedures other than LTM cell switch.

Embodiments of the present disclosure address these and other problems, difficulties, and/or issues by providing flexible and efficient techniques for managing LTM configurations in conjunction with an L3 mobility procedure for a UE, such as maintaining, releasing, modifying or adding one or more LTM configurations, or a portion thereof. Exemplary L3 mobility procedures include handover, reconfiguration with sync, PSCell change, as well as conditional mobility procedures such as conditional handover (CHO), conditional PSCell change (CPC), and conditional PSCell addition (CPA).

Some embodiments include methods for a UE to manage one or more LTM configurations when performing an L3 mobility procedure, such as by retaining, releasing, modifying, or adding the one or more LTM configurations. Other embodiments include methods for a source RAN node to manage one or more LTM configurations for a UE when performing an L3 mobility procedure for the UE, such as by retaining, releasing, modifying, or adding the one or more LTM configurations. Other embodiments include methods for a target RAN node to manage one or more LTM configurations for a UE when performing an L3 mobility procedure for the UE, such as by retaining, releasing, modifying, or adding the one or more LTM configurations.

Embodiments of the present disclosure may be particularly applicable when the L3 mobility procedure involves cells served by different gNBs, which may be referred to as inter-CU L3 mobility. Since Rel-18 only supports intra-CU (including inter-DU and intra-DU) LTM, there are cases where a UE's existing intra-CU LTM configurations need to be managed in some way in relation to an inter-CU L3 mobility procedure by/for the UE. For example, the UE's existing LTM candidate cell configuration(s) may be inapplicable to the target RAN node (or target CU) since they involve cells served by a DU associated with a different CU. Since an LTM procedure to these cells is not possible while the UE is served by the target RAN node, either the source RAN node (before L3 mobility procedure) or the target RAN node (after L3 mobility procedure) may initiate a release of at least a part of the UE's LTM configuration(s), such as the inapplicable LTM candidate cell configurations.

In some embodiments, when the source RAN node decides to perform an L3 mobility procedure, it releases the at least a part of the LTM configuration(s) and subsequently (i.e., after the release has been performed) requests the target RAN node to prepare the L3 mobility procedure (e.g., handover).

In other embodiments, the source RAN node requests the target RAN node to prepare an L3 mobility procedure for a UE, and the target RAN node determines that at least part of the UE's LTM configurations should be released. The target RAN node includes an indication in the L3 mobility command (e.g., RRCReconfiguration message) for the UE to release at least part of the UE's LTM configurations. The target RAN node may also indicate to the source RAN node (e.g., in a response to the request) that at least a part of the UE's LTM configurations should be released.

In other embodiments, the source RAN node requests the target RAN node to prepare an L3 mobility procedure for a UE, and the target RAN node determines that one or more LTM configurations (e.g., LTM candidate cell configurations) need to be added for the UE. The target RAN node includes an indication in the L3 mobility command (e.g., RRCReconfiguration message) for the UE to add the one or more LTM configurations.

In some embodiments, one or more LTM configurations for a UE are managed during configuration or execution of a conditional reconfiguration such as CHO, CPC, or CPA. For example, the UE can maintain, release, modify, or add one or more LTM configurations during execution of a conditional reconfiguration. As another example, a source RAN node determines that at least part of the UE's LTM configurations should be released during configuration of a conditional reconfiguration (e.g., CHO command) for the UE. In one embodiment, a target RAN node determines to maintain, release, modify, or add one or more LTM configurations during configuration of a conditional reconfiguration (e.g., CHO command) for the UE.

Embodiments may provide various benefits and/or advantages. For example, embodiments may facilitate correct operation of L3 mobility when LTM is also configured for a UE by releasing LTM configurations that are not applicable after an L3 mobility procedure, such as intra-CU LTM configuration(s) that are not applicable after an inter-CU L3 mobility procedure. Embodiments may also facilitate configuration of LTM for a UE during configuration or execution of an L3 mobility procedure, such as a target RAN node providing LTM configuration(s) that are applicable after the UE completes the L3 mobility procedure. Furthermore, embodiments may improve mobility in RANs (e.g., NG-RANs) by facilitating interoperability of L3 mobility and LTM.

In the present disclosure, the following terms may be used interchangeably: “L1/L2 based inter-cell mobility”, “L1/L2 mobility,” “L1-mobility,” “L1 based mobility,” “L1/L2-centric inter-cell mobility,” “L1/L2 inter-cell mobility,” “inter-cell beam management,” “inter-DU L1/L2 based inter-cell mobility”, and “L1/L2 triggered mobility” (or LTM). These terms refer to a scenario in which a UE receives lower layer (i.e., below RRC, such as MAC or PHY) signaling from a network indicating for the UE to change of its serving cell (e.g., PCell) from a source cell to a target cell. The content of the lower layer signaling may be referred to as “LTM cell switch command”. Exemplary lower layer signaling includes L1 DL control information (DCI) and L2 MAC control element (CE). Compared to conventional RRC signaling, lower layer signaling reduces processing time and interruption time during mobility and may also increase mobility robustness since the network can respond more quickly to changes in the UE's channel conditions.

The change of serving cell (e.g., PCell) may also lead to a change in SCell(s) of the same cell group, e.g., in case the command triggers the UE to change to another cell group configuration of the same type (e.g., another MCG configuration). For example, an LTM cell switch may include a change in SpCell (e.g., PCell for MCG, PSCell for SCG) and a change (e.g., addition, modification and/or release) in SCells of the same cell group.

In the present disclosure, the following terms may be used interchangeably with respect to L1/L2 inter-cell mobility: “neighbor DU,” “non-serving DU,” “candidate DU,” and “target DU.” Likewise, the terms “serving DU” and “source DU” may be used interchangeably with respect to L1/L2 inter-cell mobility.

Before the UE receives the LTM cell switch command, the UE is configured by the network with one or more “LTM candidate cell configurations” via an RRCReconfiguration message. The terms “(LTM) candidate configuration”, “LTM configuration”, “(LTM) candidate target cell configuration”, and “(LTM) target candidate (cell) configuration” may be used interchangeably with LTM candidate cell configuration.

An LTM candidate cell configuration may be included in an RRC IE such as CellGroupConfig, SpCellConfig, or SCellConfig and/or an embedded RRCReconfiguration message for an LTM candidate cell. An LTM candidate cell configuration includes configuration parameters the UE needs to operate in that LTM candidate cell when it performs an LTM cell switch procedure, e.g., upon reception of the LTM cell switch command. As some more specific examples, an LTM candidate cell configuration can include a PCell configuration and one or more SCell configurations of an MCG, or a PSCell configuration and one or more SCell configurations of an SCG. The exact content and/or structure of the IE and/or embedded message for an LTM candidate cell configuration may be called “RRC model for the candidate configuration” or more simply “RRC model”.

A UE may receive an LTM candidate cell configuration in complete form or as a delta (or difference) relative to a reference configuration (which may be signalled separately). In the latter case, the actual LTM candidate configuration is a combination of the delta configuration and the reference configuration.

The lower layer signaling from the RAN may include an identifier (or index) associated with an LTM candidate cell configuration. The identifier may be sent together with an LTM cell switch command, indicating for the UE to perform an LTM cell switch to the associated LTM candidate cell.

The term “LTM configuration” refers to a data structure that is used for or related to UE LTM operations, and includes one or more of the following elements:
One or more LTM candidate cell configurations, i.e., for respective LTM candidate cells;
Measurement configuration for LTM, e.g., L1 measurement and reporting configuration for LTM candidate cells;
Configurations for DL pre-sync for LTM, e.g., for early TCI state activation;
Configurations for UL pre-sync for LTM, e.g., for reception of PDCCH ordered preamble transmission and reception of TA;
Configurations for execution of an LTM cell switch procedure according to a given LTM candidate cell configuration (e.g., whether to perform RA, RLC reestablishment, MAC reset, PDCP recovery, etc.).
   The term “part of an LTM configuration” may refer to a subset of the elements in the above list, and/or a subset of items comprising any of the elements present (e.g., subset of configurations for DL pre-sync).

The phrase “LTM cell switch procedure” refers to the process of a UE switching (or changing) its cell from a source cell to a target cell (i.e., an LTM candidate cell) using LTM. An LTM cell switch procedure may also be referred to as “L1/L2 based inter-cell mobility execution”, “LTM execution”, “dynamic switch”, “LTM switch”, “(LTM) cell switch”, “(LTM) serving cell change”, or “(LTM) cell change”. Similarly, the phrase “switching to an LTM candidate cell configuration” means that the UE applies an LTM candidate cell configuration such that the associated candidate cell becomes its new special cell (SpCell), e.g., PCell for LTM in MCG or PSCell for LTM in SCG.

The phrase “L3 mobility procedure” generally refers to a process of a UE changing its cell from a source cell to a target cell, using an RRC procedure while in RRC_CONNECTED state, sometimes referred to as RRC mobility. Examples include handover, reconfiguration with sync, CHO, PSCell change, SN change, SN modification, MN change, conditional reconfiguration, CPC, CPA, and Dual Active Protocol Stack (DAPS) handover, or any combination thereof. An L3 mobility procedure may include one or more the following operational phases:
configuration, such as a target RAN node preparing a UE configuration for the L3 mobility procedure and sending it to a source RAN node, which provides the UE configuration to the UE;
evaluation, where the UE performs L3 measurements and the source RAN node (or UE) evaluates the measurements against execution conditions; and
execution, including the UE execution based on the received configuration and any supporting operations taken by the source RAN node and/or the target RAN node.
   As noted above, FIG. 5 shows an example of an L3 mobility procedure involving configuration, evaluation, and execution operations.

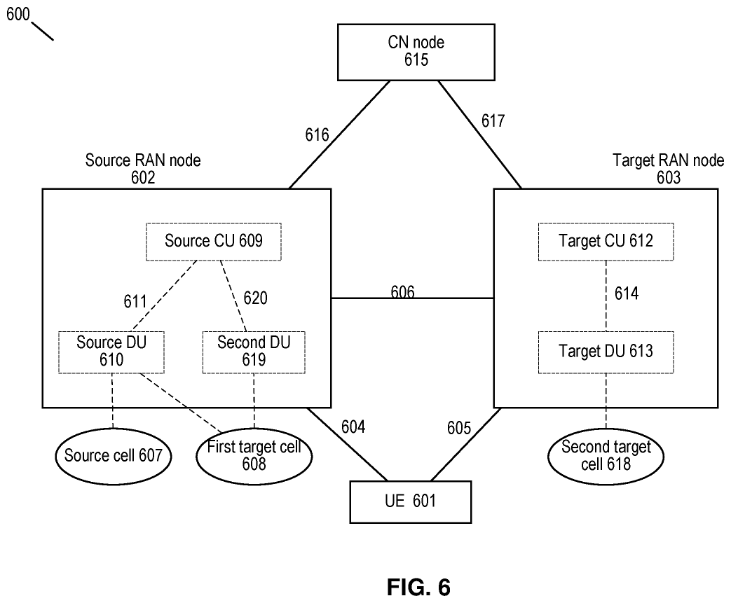

Embodiments will not be described in more detail. FIG. 6 shows an example RAN (600) in which various embodiments of the present disclosure can be implemented. The RAN (e.g., NG-RAN) includes a UE (601) configured to communicate with a source RAN node (602) over a wireless interface (604) in a source cell (607) or a first target cell (608), and to a target RAN node (603) over a wireless interface (605) in a second target cell (609). For example, the respective wireless interfaces may be NR or LTE.

In the context of an LTM procedure, the source cell may be referred to as the UE's serving cell (or special cell, SpCell) while the first target cell may be referred to as an LTM candidate cell for the UE. The second target cell may be a target cell for an L3 mobility procedure by the UE, i.e., from the source cell. In the context of a geographic arrangement, the first and second target cell may be referred to as neighbor cells of the source (or serving) cell for the UE.

When the UE is configured with dual connectivity (e.g., MR-DC or NR-DC), the source and target RAN nodes be source and target MNs or source and target SNs, respectively, depending on whether the L3 mobility procedure involves the MCG or the SCG, respectively. The source and target RAN nodes may be connected over an interface (606). If these two nodes are gNBs in an NG-RAN, the interface between them may be an Xn (or Xn-C) interface.

The source and target RAN nodes may also be arranged in a CU/DU (or split gNB) architecture such as shown in FIGS. 1 and 3-4. In such case, the source RAN node includes a source CU (609), a source DU (610), and a second DU (619), while the target RAN node includes a target CU (612) and a target DU (613). The interfaces (e.g., 611, 620, 614) between the respective CUs and DUs may be F1 interfaces. In the CU/DU (or split gNB) architecture, the source DU may provide the source cell for the UE, while the first target cell may be provided by the source DU or the second DU. Likewise, the target DU may provide the second target cell.

The RAN in FIG. 6 also includes a core network (CN) node (615), which is connected to the source and target RAN nodes via respective interfaces (616, 617). For example, the CN node may be a User Plane Function (UPF) or an Access and Mobility management Function (AMF). In such case, the respective interfaces to the RAN nodes may be NG interfaces.

In various embodiments, any of the UE, the source RAN node, or the target RAN node can manage LTM configurations for the UE in relation to an L3 mobility procedure for the UE. Some examples are discussed below.

In some embodiments, a UE can maintain one or more of its existing LTM configurations upon performing an intra-CU L3 mobility procedure, including intra-DU and intra-cell. In some embodiments, a UE can release one or more of its existing LTM configurations upon performing an inter-CU L3 mobility procedure, i.e., to a target cell provided by different RAN node than what provides the UE's source cell for the L3 mobility procedure. In other embodiments, a UE can release one or more of its existing LTM configurations upon performing any L3 mobility procedure.

In some embodiments, a UE can modify one or more of its existing LTM configurations upon performing an intra-CU L3 mobility procedure. For example, a UE can release part of one of its existing LTM configurations but maintain other parts of the LTM configuration. As another example, the UE can add to one of its existing LTM configurations, while maintaining other parts of the LTM configuration. As a more specific example, the UE may release a subset of LTM candidate cell configurations comprising the LTM configuration and/or add additional LTM candidate cell configurations to the LTM configuration, while maintaining the remainder of the LTM configuration.

In some embodiments, the UE can manage its LTM configurations (including adding new LTM configurations) in response to an indication from the RAN, such as the source RAN node or the target RAN node for the L3 mobility procedure. For example, the indication can be provided according to any of the following embodiments:
included in an RRC message (e.g., RRCReconfiguration) from the source RAN node or the target RAN node, such as in a ToAddMod structure, a ToRelease structure, or a SetupRelease structure; or
included in a MAC CE or downlink control information (DCI) sent by the source RAN node or the target RAN node.
   In other embodiments, the UE's management of LTM configurations is pre-configured, e.g., based on 3GPP specification.

In various embodiments, the UE can manage its LTM configurations (including adding new LTM configurations) during configuration, evaluation, and/or execution portion of the L3 mobility procedure. In some embodiments, the UE can manage its LTM configurations during execution of a conditional reconfiguration, such as execution of CHO, CPC, or CPA. For example, the conditional configuration for the L3 mobility candidate cell applied by the UE during execution includes an indication of whether to maintain, release, modify or add one or more LTM configurations or parts thereof (e.g., whether to add/modify or release LTM candidate cell configurations).

In some embodiments, a source RAN node (or source CU) can maintain one or more LTM configurations for the UE upon performing an intra-CU L3 mobility procedure for the UE, including intra-DU and intra-cell. In other embodiments, the source RAN node (or source CU) can maintain one or more LTM configurations for the UE that include LTM candidate cell configurations for target cells served by the target RAN node. In other words, the source RAN node can maintain LTM configurations for the UE that are applicable to the target RAN node.

In some embodiments, a source RAN node (or source CU) can release one or more LTM configurations for the UE upon performing an inter-CU L3 mobility procedure for the UE, i.e., to a target cell provided by different RAN node. In other embodiments, the source RAN node can release one or more LTM configurations for the UE upon performing any L3 mobility procedure. In other embodiments, the source RAN node (or source CU) can release one or more LTM configurations for the UE that do not include LTM candidate cell configurations for target cells served by the target RAN node. In other words, the source RAN node can release LTM configurations for the UE that are not applicable to the target RAN node.

In some embodiments, a source RAN node (or source CU) can modify one or more LTM configurations for the UE upon performing an intra-CU L3 mobility procedure. For example, a source RAN node can release part of an LTM configuration but maintain other parts of the LTM configuration. As another example, the source RAN node can add to an existing LTM configuration for the UE, while maintaining other parts of the LTM configuration. As a more specific example, the source RAN node may release a subset of LTM candidate cell configurations comprising the LTM configuration and/or add additional LTM candidate cell configurations to the LTM configuration, while maintaining the remainder of the LTM configuration.

In some embodiments, a source RAN node (or source CU) can manage one or more LTM configurations for the UE in response to an indication from a target RAN node for the L3 mobility procedure. For example, the indication can be included in a message via an Xn interface between the source RAN node and the target RAN node. As a more specific example, the indication can be included in an XnAP message such as Handover Request Acknowledge (e.g., in the F1AP content or in an RRC message embedded in a container). Optionally, the indication may also be included in an F1 message from the source CU to the source DU.

In various embodiments, the indication from the target RAN node can be any of the following:
An indication that the target RAN node does not support LTM, from which the source RAN″ node may infer that all LTM configurations for the UE;
One or more LTM candidate cell configurations that are part of an LTM configuration that needs to be released.
One or more LTM candidate cell configurations to be added to an LTM configuration; and
One or more LTM candidate cell configurations that are part of an LTM configuration that needs to be modified.

In other embodiments, the source RAN node's management of LTM configurations is pre-configured, e.g., based on 3GPP specification.

In various embodiments, the source RAN node can manage LTM configurations for the UE (including adding new LTM configurations) during configuration, evaluation, and/or execution portion of the L3 mobility procedure. In some embodiments, the source RAN node can manage LTM configurations for the UE during configuration of a conditional reconfiguration for the UE to perform CHO, CPC, or CPA. For example, the conditional configuration for the L3 mobility candidate cell (e.g., as prepared by the target RAN node serving that cell) includes an indication of whether to maintain, release, modify or add one or more LTM configurations or parts thereof (e.g., whether to add/modify or release LTM candidate cell configurations).

In some embodiments, a target RAN node (or target CU) can maintain one or more LTM configurations for the UE upon performing an intra-CU L3 mobility procedure for the UE, including intra-DU and intra-cell. In other embodiments, the target RAN node (or source CU) can maintain one or more LTM configurations for the UE that include LTM candidate cell configurations for target cells served by the target RAN node. In other words, the target RAN node can maintain LTM configurations for the UE that are applicable to the target RAN node.

In some embodiments, a target RAN node (or target CU) can release one or more LTM configurations for the UE upon performing an inter-CU L3 mobility procedure for the UE, i.e., from a source cell provided by different RAN node. In other embodiments, the target RAN node can release one or more LTM configurations for the UE upon performing any L3 mobility procedure. In other embodiments, the target RAN node (or target CU) can release one or more LTM configurations for the UE that do not include LTM candidate cell configurations for target cells served by the target RAN node. In other words, the target RAN node can release LTM configurations for the UE that are not applicable to the target RAN node.

In some embodiments, a target RAN node (or target CU) can modify one or more LTM configurations for the UE upon performing an intra-CU L3 mobility procedure. For example, a target RAN node can release part of an LTM configuration but maintain other parts of the LTM configuration. As another example, the target RAN node can add to an existing LTM configuration for the UE, while maintaining other parts of the LTM configuration. As a more specific example, the target RAN node may release a subset of LTM candidate cell configurations comprising the LTM configuration and/or add additional LTM candidate cell configurations to the LTM configuration, while maintaining the remainder of the LTM configuration.

In some embodiments, a target RAN node (or target CU) can send an indication to a source RAN node for the L3 mobility procedure, based on which the source RAN node can manage one or more LTM configurations for the UE. For example, the indication can be included in a message via an Xn interface between the source RAN node and the target RAN node. As a more specific example, the indication can be included in an XnAP message such as Handover Request Acknowledge (e.g., in the F1AP content or in an RRC message embedded in a container). Optionally, the indication may also be included in an F1 message from the source CU to the source DU.

In various embodiments, the indication from the target RAN node can be any of the following:
An indication that the target RAN node does not support LTM, from which the source RAN″ node may infer that all LTM configurations for the UE;
One or more LTM candidate cell configurations that are part of an LTM configuration that needs to be released.
One or more LTM candidate cell configurations that need to be added to an LTM configuration; and
One or more LTM candidate cell configurations that are part of an LTM configuration that needs to be modified.

In some embodiments, the target RAN can base the indication sent to the source RAN node on one or more of the following:
Whether the target RAN node supports LTM; and
UE capabilities for managing LTM configurations, an indication of which may be provided to the target RAN node by the source RAN node in a message associated with the L3 mobility procedure (e.g., handover request message).

In other embodiments, the target RAN node's management of LTM configurations is pre-configured, e.g., based on 3GPP specification.

In various embodiments, the target RAN node can manage LTM configurations for the UE (including adding new LTM configurations) during configuration, evaluation, and/or execution portion of the L3 mobility procedure. In some embodiments, the target RAN node can manage LTM configurations for the UE during configuration of a conditional reconfiguration for the UE to perform CHO, CPC, or CPA. For example, the conditional configuration for the L3 mobility candidate cell (e.g., as prepared by the target RAN node serving that cell) includes an indication of whether to maintain, release, modify or add one or more LTM configurations or parts thereof (e.g., whether to add/modify or release LTM candidate cell configurations).

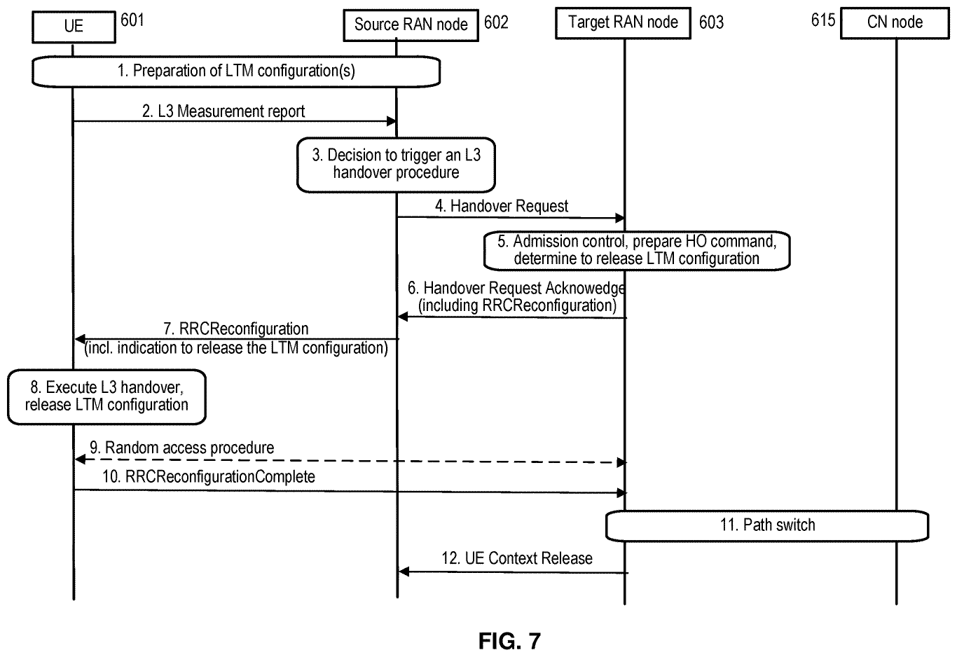

Embodiments described above can be further illustrated by FIGS. 7-10, which show signaling diagrams for various L3 mobility procedures during which LTM configurations for a UE are managed by various entities. In particular, the involved entities in FIGS. 7-10 are denoted by the same names and reference numbers as used in FIG. 6. Although the operations shown in FIGS. 7-10 are given numerical labels, this is done to facilitate explanation rather than to imply or require any specific operational order, unless expressly stated otherwise.

FIG. 7 shows a signaling diagram for an L3 mobility procedure for a UE from a source cell served by a source RAN node to a target cell served by a target RAN node, according to some embodiments of the present disclosure.

In operation 1, which can be considered a pre-requisite, the UE is prepared with at least one LTM configuration, which will be referred to below as “the LTM configuration” for clarity and brevity. In operations 2-3, the source RAN node receives from the UE an L3 measurement report and decides to trigger (or initiate) an L3 mobility procedure for the UE, in particular a L3 handover procedure to a target cell served by the target RAN node. In operation 4, the source RAN node transmits a Handover Request message to the target RAN node, indicating a request to prepare handover for the UE to the target cell. The message includes various parameters of the UE's current configuration in the source cell, including the LTM configuration.

In operation 5, the target RAN node performs admission control and prepares a handover command message, in this example an RRCReconfiguration message including reconfiguration with sync. The target RAN node also determines how to manage LTM configurations for the UE. In this example the target RAN node determines to release the LTM configuration and therefore it includes an indication to release the LTM configuration in or with the RRCReconfiguration message. In operation 6, the target RAN node transmits a Handover Request Acknowledge message to the source RAN node to confirm the successful preparation of L3 handover for the UE to the target cell. This message includes the handover command message (prepared in operation 5) and the indication to release the LTM configuration. In some embodiments, the indication to release the LTM configuration is included in the RRCReconfiguration message in the RRC container in the Handover Request Acknowledge message. In other embodiments, the Handover Request Acknowledge includes an XnAP information element containing the indication to release the LTM configuration.

In operation 7, the source RAN node releases (e.g., discards or deletes) its stored LTM configuration for the UE and sends the UE the handover command message and the indication received in operation 6. In some embodiments, the handover command message is an RRCReconfiguration message with reconfiguration with sync and includes the indication to release the LTM configuration. In operation 8, based on message received in operation 7, the UE initiates the L3 handover to the target cell. In conjunction with the L3 handover, the UE releases the LTM configuration according to the received indication.

In operations 9-10, the UE performs a random access procedure (if needed) in the target cell and transmits a handover complete message (e.g., RRCReconfigurationComplete) to the target RAN node to confirm the successful handover to the target cell. In operation 11, the target RAN node initiates the path switch of the data path towards the CN node. In operation 12, the target RAN node completes the handover procedure by requesting the source RAN node to release the UE context, based on which the source RAN node deletes its stored context for the UE.

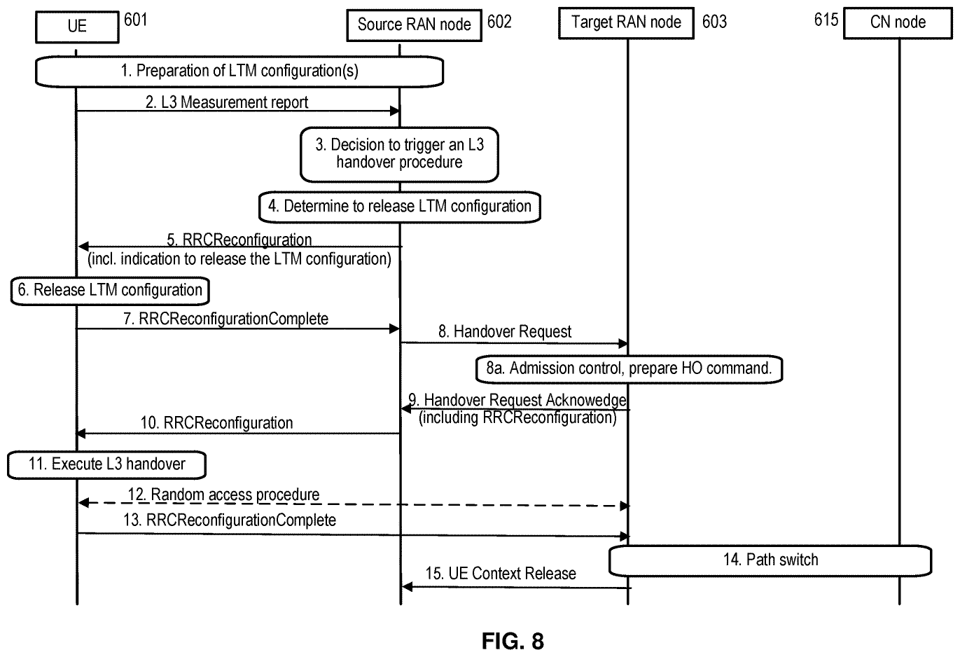

FIG. 8 shows a signaling diagram for an L3 mobility procedure for a UE from a source cell served by a source RAN node to a target cell served by a target RAN node, according to other embodiments of the present disclosure.

Operations 1-3 are identical to operations 1-3 in FIG. 7, described above. In operation 4, the source RAN node determines how to manage the LTM configuration for the UE. In this example, the source RAN node determines to release the LTM configuration. In operation 5, the source RAN node releases (e.g., discards or deletes) its stored LTM configuration for the UE and sends the UE an indication to release the LTM configuration. In this example, the indication is sent in an RRCReconfiguration message.

In operations 6-7, the UE releases the (e.g., discards or deletes) its stored LTM configuration according to the received indication and sends the source RAN node an RRCReconfigurationComplete message to confirm that the procedure was completed. In operation 8, the source RAN node transmits a Handover Request message to the target RAN node, indicating a request to prepare handover for the UE to the target cell. The message includes various parameters of the UE's current configuration in the source cell but does not include the previously released LTM configuration.

In operation 8a, the target RAN node performs admission control and prepares a handover command message, in this example an RRCReconfiguration message including reconfiguration with sync. In operation 9, the target RAN node transmits a Handover Request Acknowledge message to the source RAN node to confirm the successful preparation of L3 handover for the UE to the target cell. This message includes the handover command message.

In operation 10, the source RAN node sends the UE the handover command message received in operation 9, e.g., as an RRCReconfiguration message with reconfiguration with sync. In operation 11, based on message received in operation 10, the UE initiates the L3 handover to the target cell. Operations 12-15 are identical to operations 9-12 of FIG. 7, described above.

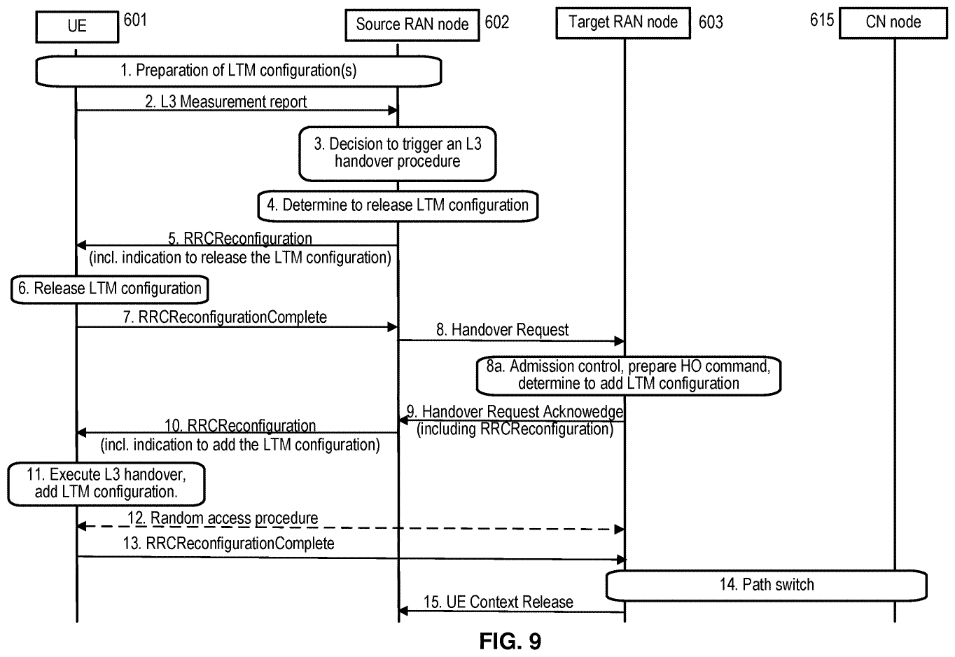

FIG. 9 shows a signaling diagram for an L3 mobility procedure for a UE from a source cell served by a source RAN node to a target cell served by a target RAN node, according to other embodiments of the present disclosure.

Operations 1-8 are identical to operations 1-8 in FIG. 8, described above.

In operation 8a, the target RAN node performs admission control and prepares a handover command message, in this example an RRCReconfiguration message including reconfiguration with sync. The target RAN node also determines how to manage LTM configurations for the UE. In this example the target RAN node determines to add an LTM configuration and consequently includes an indication to add an LTM configuration in or with the RRCReconfiguration message. In some embodiments, the target RAN node may include the LTM configuration to be added in or with the RRCReconfiguration message.

In operation 9, the target RAN node transmits a Handover Request Acknowledge message to the source RAN node to confirm the successful preparation of L3 handover for the UE to the target cell. This message includes the handover command message (prepared in operation 8a) and the indication to add an LTM configuration (and optionally the LTM configuration to be added). In some embodiments, the indication to add an LTM configuration is included in the RRCReconfiguration message in the RRC container in the Handover Request Acknowledge message. In other embodiments, the Handover Request Acknowledge includes an XnAP information element containing the indication to add an LTM configuration.

In operation 10, the source RAN node sends the UE the handover command message and the indication received in operation 9. In some embodiments, the handover command message is an RRCReconfiguration message with reconfiguration with sync and includes the indication to add an LTM configuration (and optionally the LTM configuration to be added). In operation 11, based on message received in operation 10, the UE initiates the L3 handover to the target cell. In conjunction with the L3 handover, the UE add an LTM configuration according to the received indication. Operations 12-15 are identical to operations 9-12 of FIG. 7, described above.

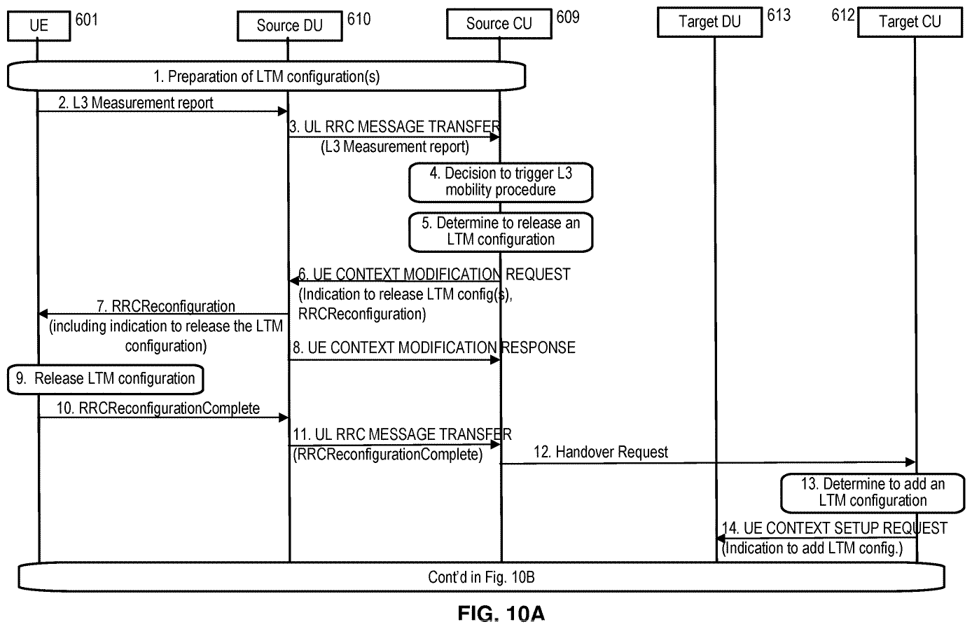

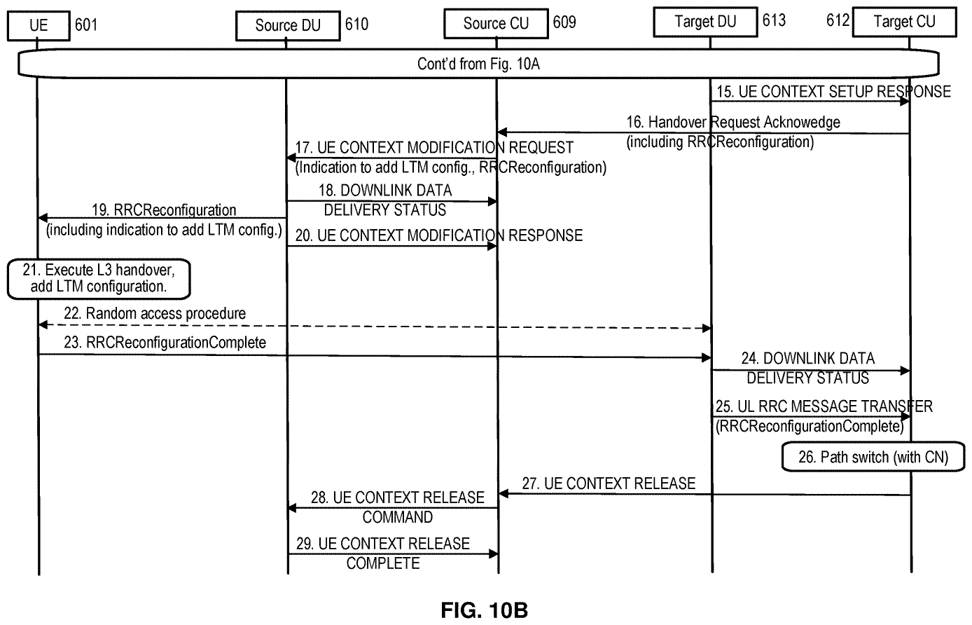

FIG. 10 (which includes FIGS. 10A-B) shows a signaling diagram for an L3 mobility procedure for a UE from a source cell served by a source RAN node to a target cell served by a target RAN node, according to other embodiments of the present disclosure. In particular, FIG. 10 involvement of the source DU and CU of the source RAN node as well as the target DU and CU of the target RAN node.

In operation 1, which can be considered a pre-requisite, the UE is prepared with at least one LTM configuration, which will be referred to below as “the LTM configuration” for clarity and brevity. The source CU performs this operation with the UE. In operations 2-3, the source DU receives an L3 measurement report from the UE and forwards the report to the source CU in an UL RRC MESSAGE TRANSFER message.

In operation 4, based on the L3 measurement report, the source CU decides to trigger (or initiate) an L3 mobility procedure for the UE, in particular a L3 handover procedure to a target cell served by a target CU of the target RAN node. In operation 5, the source CU determines how to manage the LTM configuration for the UE in relation to the L3 mobility procedure. In this example, the source RAN node determines to release the LTM configuration.

In operation 6, the source CU sends to the source DU a UE CONTEXT MODIFICATION REQUEST message with an indication to release the LTM configuration for the UE. The message also includes an RRCReconfiguration message that includes an indication to release the LTM configuration. In operation 7, the source DU releases (e.g., discards or deletes) its stored LTM configuration for the UE and sends the UE an indication to release the LTM configuration. In this example, the indication is sent in an RRCReconfiguration message. In operation 8, the source DU sends the source DU a UE CONTEXT MODIFICATION RESPONSE message including a confirmation that LTM configuration was released.

In some embodiments, the source CU may include in the UE CONTEXT MODIFICATION REQUEST message of operation 6 a query about the latest configuration for the UE. If so, the source DU includes in the UE CONTEXT MODIFICATION RESPONSE message of operation 7 complete configuration information for the UE.

In operations 9-10, the UE releases the (e.g., discards or deletes) its stored LTM configuration according to the received indication and sends the source DU an RRCReconfigurationComplete message to confirm that the procedure was completed. In operation 11, the source DU forwards the received RRCReconfigurationComplete message to the source CU in an UL MESSAGE TRANSFER message.

In operation 12, the source CU transmits a Handover Request message to the target CU, indicating a request to prepare handover for the UE to the target cell. The message includes various parameters of the UE's current configuration in the source cell but does not include the previously released LTM configuration.

In operation 13, the target CU determines how to manage LTM configurations for the UE. In this example the target CU determines to add an LTM configuration and consequently includes an indication to add an LTM configuration in a UE CONTEXT SETUP REQUEST message sent to the target DU in operation 14. This message also requests the target DU to prepare a lower layer configuration for the UE in the target cell, including relevant parts of the LTM configuration. In operation 15, based on the UE CONTEXT SETUP REQUEST message, the target DU performs admission control, prepares the requested UE configuration, and returns this to the target CU in a UE CONTEXT SETUP RESPONSE message.

In operation 16, the target CU prepares a handover command message (e.g., RRCReconfiguration message with reconfiguration with sync) based on the received UE configuration and includes an indication to add an LTM configuration in or with the RRCReconfiguration message. The target CU sends the prepared handover command (e.g., RRCReconfiguration message with reconfiguration with sync) and the indication to the source CU in a Handover Request Acknowledge message. In some embodiments, the indication to add an LTM configuration is included in the RRCReconfiguration message in an RRC container in the Handover Request Acknowledge message. In other embodiments, the Handover Request Acknowledge includes an XnAP information element containing the indication to add an LTM configuration.

In operation 17, the source CU transmits to the source DU a UE CONTEXT MODIFICATION REQUEST message that includes the handover command message and the indication to add an LTM configuration for the UE, received in operation 16, together with an indication to DL data transmission. In operation 18, the source DU also sends a DOWNLINK DATA DELIVERY STATUS frame to inform the source CU about unsuccessfully transmitted DL data to the UE. In operation 19, the source DU forwards the handover command and the indication to add an LTM configuration to the UE. In operation 20, the source DU responds to the gNB-CU with a UE CONTEXT SETUP RESPONSE message, indicating successful provisioning of the handover command to the UE.

In operation 21, the UE executes an L3 handover to the target cell in accordance with the received handover command and adds an LTM configuration in accordance with the received indication. In operations 22-23, the UE performs a random access procedure (if needed) in the target cell and transmits a handover complete message (e.g., RRCReconfigurationComplete) to the target DU to confirm the successful handover to the target cell. In operation 24, the target DU sends a DOWNLINK DATA DELIVERY STATUS frame to inform the target CU about successfully transmitted DL data to the UE in the target cell. In operation 25, the target DU forwards the handover complete message (e.g., RRCReconfigurationComplete) received in operation 23 to the target CU.

In operation 26, the target CU initiates the path switch of the data path towards the CN node. In operation 27, the target CU completes the handover procedure by requesting the source CU to release the UE context. In operations 28-29, the source CU requests the source DU to release the UE context and receives acknowledgement of this action.

Techniques of the present disclosure can also be embodied in 3GPP specifications. The following is some example text for 3GPP TS 38.423 (XnAP protocol specification), with ellipses denoting text that has been omitted for brevity and underline denoting text that is particularly relevant for embodiments of the present disclosure.
***Begin 3GPP 38.423 text***
8.2.1 Handover Preparation
8.2.1.1 General
   This procedure is used to establish necessary resources in an NG-RAN node for an incoming handover. If the procedure concerns a conditional handover, parallel transactions are allowed. Possible parallel requests are identified by the target cell ID when the source UE AP IDs are the same. The procedure uses UE-associated signalling.

### 8.2.1.2 Successful Operation

If the HANDOVER REQUEST ACKNOWLEDGE message contains the LIM Release Indicator IE the source NG-RAN node will release the LTM configuration.

### 9.1.1.2 Handover Request Acknowledge

This message is sent by the target NG-RAN node to inform the source NG-RAN node about the prepared resources at the target.
Direction: target NG-RAN node→source NG-RAN node.

| IE/Group Name | Pres. | Range | IE type/ref. | Semantics description |
|---|---|---|---|---|
| Message Type | M | | 9.2.3.1 | |
| Source NG-RAN node | M | | NG-RAN node UE | Allocated at the source |
| UE XnAP ID | | | XnAP ID 9.2.3.16 | NG-RAN node |
| . . . | | | | |
| LTM Release Indicator | O | | ENUMERATED | |
| | | | (release, . . . ) | |

***End 3GPP 38.423 text***

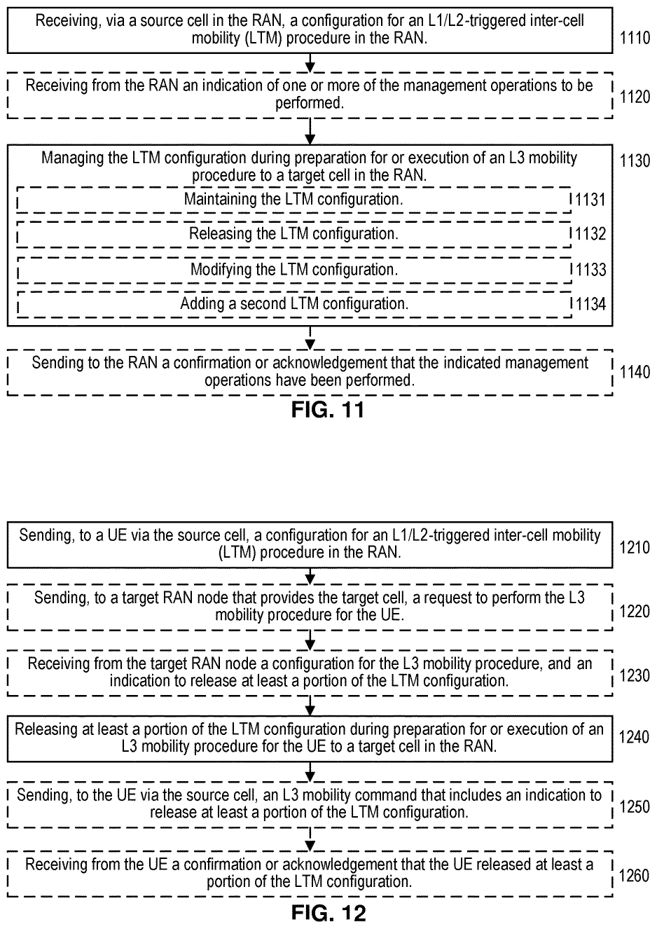

The embodiments described above can be further illustrated with reference to FIGS. 11-13, which depict exemplary methods (e.g., procedures) for a UE, a source RAN node, and a target RAN node, respectively. Put differently, various features of the operations described below correspond to various embodiments described above. The exemplary methods shown in FIGS. 11-13 can be used cooperatively to provide benefits, advantages, and/or solutions to problems described herein. Although FIGS. 11-13 illustrate the exemplary methods by specific blocks in particular orders, the operations corresponding to the blocks can be performed in different orders than shown and can be combined and/or divided into blocks and/or operations having different functionality than shown. Optional blocks or operations are indicated by dashed lines.

More specifically, FIG. 11 illustrates an exemplary method (e.g., procedure) for a UE configured to perform a layer-3 (L3) mobility procedure in a RAN, according to various embodiments of the present disclosure. The exemplary method shown in FIG. 11 can be performed by a UE (e.g., wireless device) such as described elsewhere herein.

The exemplary method includes the operations of block 1110, where the UE receives, via a source cell in the RAN, a configuration for an LTM procedure in the RAN. The exemplary method also include the operations of block 1130, where the UE can manage the LTM configuration during preparation for or execution of an L3 mobility procedure to a target cell in the RAN. This includes one or more of the following management operations, labelled with corresponding sub-block numbers:
(1131) maintaining the LTM configuration;
(1132) releasing the LTM configuration;
(1133) modifying the LTM configuration; and
(1134) adding a second LTM configuration.

In some embodiments, managing the LTM configuration in block 1130 is based on whether the target cell for the L3 mobility procedure is provided by a different RAN node than the source cell. For example, releasing the LTM configuration is performed in block 1132 when the target cell is provided by a different RAN node than the source cell, and maintaining the LTM configuration is performed in sub-block 1131 when the target cell is provided by a same RAN node as the source cell.

In some embodiments, the exemplary method also includes the operations of block 1120, where the UE receives from the RAN an indication of one or more of the management operations to be performed. In such case, managing the LTM configuration is performed based on the indication.

In some of these embodiments, the indication is received in one of the following: an L3 (e.g., RRC) message via the source cell or the target cell, an L2 (e.g., MAC) message via the source cell or the target cell, or an L1 (e.g., PHY) message via the source cell. As a more specific example, the indication may be received in an L3 mobility command (e.g., handover command), such as described above in relation to various FIGS. 7-10. In some variants, the indication in one of the following data structures of the L3 mobility command: ToAddMod, ToRelease, or SetupRelease.

In some of these embodiments, the L3 mobility procedure is a non-conditional mobility procedure and the indication is received in or with a command to perform the non-conditional mobility procedure. In other of these embodiments, the L3 mobility procedure is a conditional mobility procedure and the indication is received in or with a conditional configuration for the conditional mobility procedure.

In some of these embodiments, the indication includes one or more of the following:
an indication to release the LTM configuration;
a second LTM configuration to be added;
an indication of a part of the LTM configuration to be released or modified; and
information to be added to the LTM configuration.
   In some variants of these embodiments, the indicated part of the LTM configuration to be released or modified includes one or more LTM candidate cell configurations. In some variants of these embodiments, the information to be added includes one or more LTM candidate cell configurations.

In some of these embodiments, the exemplary method also includes the operations of block 1140, where the UE sends to the RAN (e.g., to source or target RAN node, as appropriate) a confirmation or acknowledgement that the indicated management operations have been performed.

In some embodiments, the LTM configuration includes one or more of the following:
one or more LTM candidate cell configurations;
measurement and reporting configuration for LTM candidate cells;
downlink (DL) pre-synchronization configuration for LTM;
uplink (UL) pre-synchronization configuration for LTM; and
execution configurations for LTM cell switch procedures to respective LTM candidate cells.
   In some of these embodiments, when the LTM configuration includes the one or more LTM candidate cell configurations, modifying the LTM configuration in sub-block 1133 includes one or more of the following operations:
releasing one of the LTM candidate cell configurations while maintaining other of the LTM candidate cell configurations; and
adding a further LTM candidate cell configuration to the one or more LTM candidate cell configurations.

In various embodiments, the L3 mobility procedure can be any of the following: handover, dual active protocol stack (DAPS) handover reconfiguration with sync, conditional handover, conditional reconfiguration, primary SCG cell (PSCell) change, conditional PSCell change, conditional PSCell addition, secondary node (SN) change, SN modification, master node (MN) change.

In addition, FIG. 12 illustrates an exemplary method (e.g., procedure) for a RAN node configured to provide a source cell for UE L3 mobility procedures, according to various embodiments of the present disclosure. The exemplary method shown in FIG. 12 can be performed by a RAN node (e.g., base station, gNB, etc.) or unit(s) thereof (e.g., CU and/or DU) such as described elsewhere herein.

The exemplary method includes the operations of block 1210, where the RAN node sends, to a UE via the source cell, a configuration for an LTM procedure in the RAN. The exemplary method also includes the operations of block 1240, where the RAN node releases at least a portion of the LTM configuration during preparation for or execution of an L3 mobility procedure for the UE to a target cell in the RAN.

In some embodiments, releasing at least a portion of the LTM configuration in block 1240 is performed based on the target cell for the L3 mobility procedure being provided by another RAN node.

In some embodiments, the exemplary method also includes the operations of block 1250, where the RAN node sends to the UE an indication to release at least a portion of the LTM configuration. In some of these embodiments, the indication is sent in one of the following via the source cell: an L3 (e.g., RRC) message, an L2 (e.g., MAC) message, or an L1 (e.g., PHY) message. As a more specific example, the indication may be sent in an L3 mobility command (e.g., handover command), such as described above in relation to various FIGS. 7-10. In some variants of these embodiments, the indication in one of the following data structures of the L3 mobility command: ToAddMod, ToRelease, or SetupRelease.

In some of these embodiments, the L3 mobility procedure is a non-conditional mobility procedure and the indication is sent to the UE in or with a command to perform the non-conditional mobility procedure. In other of these embodiments, the L3 mobility procedure is a conditional mobility procedure and the indication is sent to the UE in or with a conditional configuration for the conditional mobility procedure.

In some of these embodiments, the exemplary method can also include the operations of block 1240, where the RAN node can receive from the UE a confirmation or acknowledgement that the indicated management operations have been performed.

In some embodiments, the LTM configuration includes one or more of the following:
one or more LTM candidate cell configurations;
measurement and reporting configuration for LTM candidate cells;
DL pre-synchronization configuration for LTM;
UL pre-synchronization configuration for LTM; and
execution configurations for LTM cell switch procedures to respective LTM candidate cells.

In some embodiments, the exemplary method also includes the operations of block 1220-1230, where the RAN node sends, to a target RAN node that provides the target cell, a request to perform the L3 mobility procedure for the UE and receives the following from the target RAN node: a configuration for the L3 mobility procedure for the UE, and an indication to release at least a portion of the LTM configuration. In such case, releasing least a portion of the LTM configuration in block 1240 is responsive to the indication received in block 1230.

In some of these embodiments, the indication to release at least a portion of the LTM configuration is one of the following:
an indication that the target RAN node does not support LTM;
an explicit indication to release the LTM configuration; and
an indication of one or more LTM candidate cell configurations, of the LTM configuration, that are to be released.

In various embodiments, the L3 mobility procedure can be any of the following: handover, DAPS handover reconfiguration with sync, conditional handover, conditional reconfiguration, PSCell change, conditional PSCell change, conditional PSCell addition, SN change, SN modification, MN change.

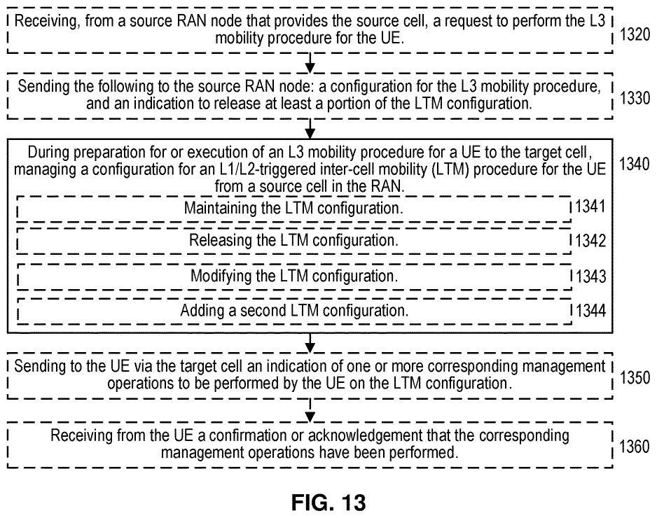

In addition, FIG. 13 illustrates an exemplary method (e.g., procedure) for a RAN node configured to provide a target cell for UE L3 mobility procedures, according to various embodiments of the present disclosure. The exemplary method shown in FIG. 13 can be performed by a RAN node (e.g., base station, gNB, etc.) or unit(s) thereof (e.g., CU and/or DU) such as described elsewhere herein.

The exemplary method includes the operations of block 1340, where during preparation for or execution of an L3 mobility procedure for a UE to the target cell, the RAN node manages a configuration for an LTM procedure for the UE from a source cell in the RAN. This includes one or more of the following management operations, labelled with corresponding sub-block numbers:
(1341) maintaining the LTM configuration;
(1342) releasing the LTM configuration;
(1343) modifying the LTM configuration; and
(1344) adding a second LTM configuration.

In some embodiments, managing the LTM configuration in block 1340 is based on whether the source cell for the L3 mobility procedure is provided by another RAN node. In some of these embodiments, releasing the LTM configuration is performed in sub-block 1342 when the source cell is provided by another RAN node while maintaining the LTM configuration is performed in sub-block 1341 when the source cell is provided by the RAN node.

In some embodiments, the exemplary method also includes the operations of block 1350, where the RAN node sends to the UE an indication of one or more corresponding management operations to be performed by the UE on the LTM configuration. In some of these embodiments, the indication is sent in one of the following via the target cell: an L3 (e.g., RRC) message, or an L2 (e.g., MAC) message. As a more specific example, the indication is sent in an L3 mobility command (e.g., handover command), such as described above in relation to various FIGS. 7-10. In some variants, the indication is included in one of the following data structures of the L3 mobility command: ToAddMod, ToRelease, or SetupRelease.

In some of these embodiments, the indication sent to the UE includes one or more of the following:
an indication that the target RAN node does not support LTM;
an indication to release the LTM configuration;
a second LTM configuration to be added;
an indication of a part of the LTM configuration to be released or modified; and
information to be added to the LTM configuration.

In some of these embodiments, the exemplary method also includes the operations of block 1360, where the RAN node receives from the UE a confirmation or acknowledgement that the corresponding management operations have been performed.

In some embodiments, the LTM configuration includes one or more of the following:
one or more LTM candidate cell configurations;
measurement and reporting configuration for LTM candidate cells;
DL pre-synchronization configuration for LTM;
UL pre-synchronization configuration for LTM; and
execution configurations for LTM cell switch procedures to respective LTM candidate cells.
   In some of these embodiments, when the LTM configuration includes the one or more LTM candidate cell configurations, modifying the LTM configuration in sub-block 1343 includes one or more of the following operations:
releasing one of the LTM candidate cell configurations while maintaining other of the LTM candidate cell configurations; and
adding a further LTM candidate cell configuration to the one or more LTM candidate cell configurations.

In some embodiments, the exemplary method also includes the operations of block 1320-1330, where the RAN node receives, from a source RAN node that provides the source cell, a request to perform the L3 mobility procedure for the UE; and sends the following to the source RAN node: a configuration for the L3 mobility procedure for the UE, and an indication to release at least a portion of the LTM configuration.

In some of these embodiments the request to perform the L3 mobility procedure includes at least part of the LTM configuration. In some of these embodiments, the indication to release at least a portion of the LTM configuration is one of the following:
an indication that the target RAN node does not support LTM;
an explicit indication to release the LTM configuration;
a second LTM configuration to be added; and
an indication of one or more LTM candidate cell configurations, of the LTM configuration, that are to be released.

In various embodiments, the L3 mobility procedure can be any of the following: handover, DAPS handover reconfiguration with sync, conditional handover, conditional reconfiguration, PSCell change, conditional PSCell change, conditional PSCell addition, SN change, SN modification, MN change.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

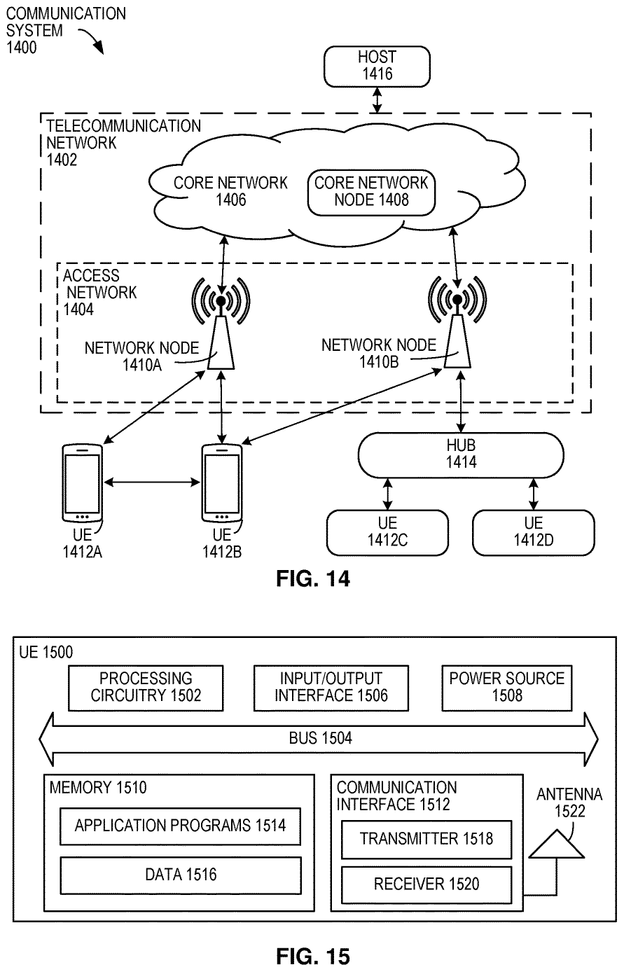

FIG. 14 shows an example of a communication system 1400 in accordance with some embodiments. In this example, communication system 1400 includes a telecommunication network 1402 that includes an access network 1404 (e.g., RAN) and a core network 1406, which includes one or more core network nodes 1408. Access network 1404 includes one or more access network nodes, such as network nodes 1410a-b (one or more of which may be generally referred to as network nodes 1410), or any other similar 3GPP access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, telecommunication network 1402 includes one or more Open-RAN (ORAN) network nodes. An ORAN network node is a node in telecommunication network 1402 that supports an ORAN specification (e.g., a specification published by the O-RAN Alliance, or any similar organization) and may operate alone or together with other nodes to implement one or more functionalities of any node in telecommunication network 1402, including one or more network nodes 1410 and/or core network nodes 1408.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. Network nodes 1410 facilitate direct or indirect connection of UEs, such as by connecting UEs 1412a-d (one or more of which may be generally referred to as UEs 1412) to core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1400 may include any number of wired or wireless networks, network nodes, UEs, and/or any other components or systems that may facilitate or participate in the communication of data and/or signals whether via wired or wireless connections. Communication system 1400 may include and/or interface with any type of communication, telecommunication, data, cellular, radio network, and/or other similar type of system.

UEs 1412 may be any of a wide variety of communication devices, including wireless devices arranged, configured, and/or operable to communicate wirelessly with network nodes 1410 and other communication devices. Similarly, network nodes 1410 are arranged, capable, configured, and/or operable to communicate directly or indirectly with UEs 1412 and/or with other network nodes or equipment in telecommunication network 1402 to enable and/or provide network access, such as wireless network access, and/or to perform other functions, such as administration in telecommunication network 1402.

In the depicted example, core network 1406 connects network nodes 1410 to one or more hosts, such as host 1416. These connections may be direct or indirect via one or more intermediary networks or devices. In other examples, network nodes may be directly coupled to hosts. Core network 1406 includes one or more core network nodes (e.g., 1408) that are structured with hardware and software components. Features of these components may be substantially similar to those described with respect to the UEs, network nodes, and/or hosts, such that the descriptions thereof are generally applicable to the corresponding components of core network node 1408.

Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1416 may be under the ownership or control of a service provider other than an operator or provider of access network 1404 and/or telecommunication network 1402, and may be operated by the service provider or on behalf of the service provider. Host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1402 is a cellular network that implements 3GPP standardized features. Accordingly, telecommunication network 1402 may support network slicing to provide different logical networks to different devices that are connected to telecommunication network 1402. For example, telecommunication network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1412 are configured to transmit and/or receive information without direct human interaction. For instance, a UE may be designed to transmit information to access network 1404 on a predetermined schedule, when triggered by an internal or external event, or in response to requests from access network 1404. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1414 communicates with access network 1404 to facilitate indirect communication between one or more UEs (e.g., 1412c and/or 1412d) and network nodes (e.g., 1410b). In some examples, hub 1414 may be a controller, router, content source and analytics, or any of the other communication devices described herein regarding UEs. For example, hub 1414 may be a broadband router enabling access to core network 1406 for the UEs. As another example, hub 1414 may be a controller that sends commands or instructions to one or more actuators in the UEs. Commands or instructions may be received from the UEs, network nodes 1410, or by executable code, script, process, or other instructions in hub 1414. As another example, hub 1414 may be a data collector that acts as temporary storage for UE data and, in some embodiments, may perform analysis or other processing of the data. As another example, hub 1414 may be a content source. For example, for a UE that is a VR headset, display, loudspeaker or other media delivery device, hub 1414 may retrieve VR assets, video, audio, or other media or data related to sensory information via a network node, which hub 1414 then provides to the UE either directly, after performing local processing, and/or after adding additional local content. In still another example, hub 1414 acts as a proxy server or orchestrator for the UEs, in particular if one or more of the UEs are low energy IoT devices.

Hub 1414 may have a constant/persistent or intermittent connection to network node 1410b. Hub 1414 may also allow for a different communication scheme and/or schedule between hub 1414 and UEs (e.g., 1412c and/or 1412d), and between hub 1414 and core network 1406. In other examples, hub 1414 is connected to core network 1406 and/or one or more UEs via a wired connection. Moreover, hub 1414 may be configured to connect to an M2M service provider over access network 1404 and/or to another UE over a direct connection. In some scenarios, UEs may establish a wireless connection with network nodes 1410 while still connected via hub 1414 via a wired or wireless connection. In some embodiments, hub 1414 may be a dedicated hub—that is, a hub whose primary function is to route communications to/from the UEs from/to network node 1410b. In other embodiments, hub 1414 may be a non-dedicated hub—that is, a device which is capable of operating to route communications between the UEs and network node 1410b, but which is additionally capable of operating as a communication start and/or end point for certain data channels.

FIG. 15 shows a UE 1500 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1500 includes processing circuitry 1502 that is operatively coupled via a bus 1504 to an input/output interface 1506, a power source 1508, a memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

Processing circuitry 1502 is configured to process instructions and data and may be configured to implement any sequential state machine operative to execute instructions stored as machine-readable computer programs in memory 1510. Processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1502 may include multiple central processing units (CPUs).

In the example, input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1508 is structured as a battery or battery pack. Other types of power sources, such as an external power source (e.g., an electricity outlet), photovoltaic device, or power cell, may be used. Power source 1508 may further include power circuitry for delivering power from power source 1508 itself, and/or an external power source, to the various parts of UE 1500 via input circuitry or an interface such as an electrical power cable. Delivering power may be, for example, for charging power source 1508. Power circuitry may perform any formatting, converting, or other modification to the power from power source 1508 to make the power suitable for the respective components of UE 1500 to which power is supplied.

Memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1510 includes one or more application programs 1514, such as an operating system, web browser application, a widget, gadget engine, or other application, and corresponding data 1516. Memory 1510 may store, for use by UE 1500, any of a variety of various operating systems or combinations of operating systems.

Memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1510 may allow UE 1500 to access instructions, application programs and the like, stored on transitory or non-transitory memory media, to off-load data, or to upload data. An article of manufacture, such as one utilizing a communication system may be tangibly embodied as or in memory 1510, which may be or comprise a device-readable storage medium.

Processing circuitry 1502 may be configured to communicate with an access network or other network using communication interface 1512. Communication interface 1512 may comprise one or more communication subsystems and may include or be communicatively coupled to an antenna 1522. Communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, transmitter 1518 and receiver 1520 may be coupled to one or more antennas (e.g., antenna 1522) and may share circuit components, software or firmware, or alternatively be implemented separately.

In the illustrated embodiment, communication functions of communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1500 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

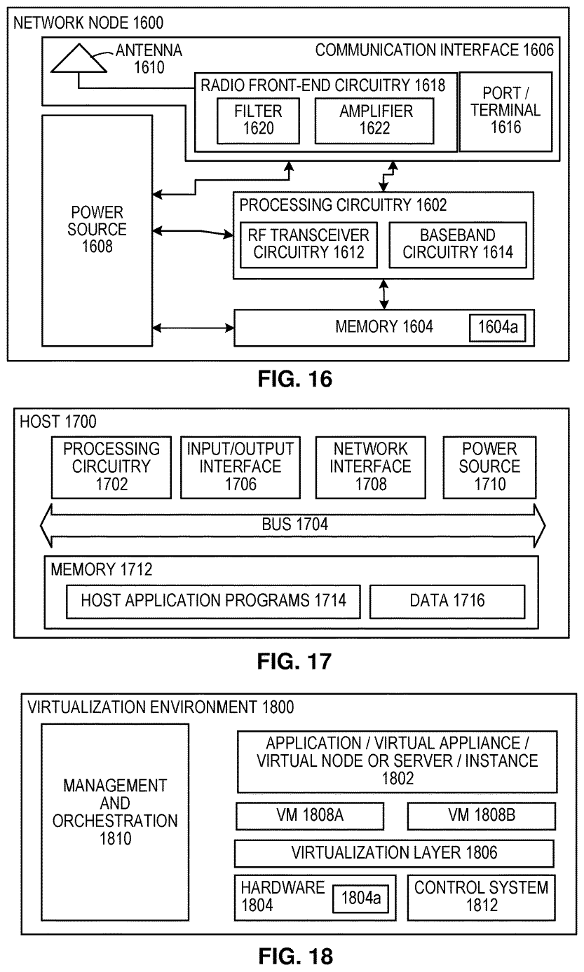

FIG. 16 shows a network node 1600 in accordance with some embodiments. Examples of network nodes include, but are not limited to, access points (APs) (e.g., radio access points), base stations (e.g., radio base stations, Node Bs, eNBs, gNBs), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1600 includes processing circuitry 1602, memory 1604, communication interface 1606, and power source 1608. Network node 1600 may be composed of multiple physically separate components (e.g., a NodeB component and a RNC component, or a BTS component and a BSC component, etc.), which may each have their own respective components. In certain scenarios in which network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). Network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

Processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as memory 1604, to provide network node 1600 functionality.

In some embodiments, processing circuitry 1602 includes a system on a chip (SOC). In some embodiments, processing circuitry 1602 includes one or more of radio frequency (RF) transceiver circuitry 1612 and baseband processing circuitry 1614. In some embodiments, RF transceiver circuitry 1612 and baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

Memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1602. Memory 1604 may store any suitable instructions, data, or information, including a computer program, software, an application including one or more of logic, rules, code, tables, and/or other instructions (collected denoted computer program 1604a, which may be in the form of a computer program product) capable of being executed by processing circuitry 1602 and utilized by network node 1600. Memory 1604 may be used to store any calculations made by processing circuitry 1602 and/or any data received via communication interface 1606. In some embodiments, processing circuitry 1602 and memory 1604 is integrated.

Communication interface 1606 is used in wired or wireless communication of signaling and/or data between a network node, access network, and/or UE. As illustrated, communication interface 1606 comprises port(s)/terminal(s) 1616 to send and receive data, for example to and from a network over a wired connection. Communication interface 1606 also includes radio front-end circuitry 1618 that may be coupled to, or in certain embodiments a part of, antenna 1610. Radio front-end circuitry 1618 comprises filters 1620 and amplifiers 1622. Radio front-end circuitry 1618 may be connected to an antenna 1610 and processing circuitry 1602. The radio front-end circuitry may be configured to condition signals communicated between antenna 1610 and processing circuitry 1602. Radio front-end circuitry 1618 may receive digital data that is to be sent out to other network nodes or UEs via a wireless connection. Radio front-end circuitry 1618 may convert the digital data into a radio signal having the appropriate channel and bandwidth parameters using a combination of filters 1620 and/or amplifiers 1622. The radio signal may then be transmitted via antenna 1610. Similarly, when receiving data, antenna 1610 may collect radio signals which are then converted into digital data by radio front-end circuitry 1618. The digital data may be passed to processing circuitry 1602. In other embodiments, the communication interface may comprise different components and/or different combinations of components.

In certain alternative embodiments, network node 1600 does not include separate radio front-end circuitry 1618, instead, processing circuitry 1602 includes radio front-end circuitry and is connected to antenna 1610. Similarly, in some embodiments, all or some of RF transceiver circuitry 1612 is part of communication interface 1606. In still other embodiments, communication interface 1606 includes one or more ports or terminals 1616, radio front-end circuitry 1618, and RF transceiver circuitry 1612, as part of a radio unit (not shown), and communication interface 1606 communicates with baseband processing circuitry 1614, which is part of a digital unit (not shown).

Antenna 1610 may include one or more antennas, or antenna arrays, configured to send and/or receive wireless signals. Antenna 1610 may be coupled to radio front-end circuitry 1618 and may be any type of antenna capable of transmitting and receiving data and/or signals wirelessly. In certain embodiments, antenna 1610 is separate from network node 1600 and connectable to network node 1600 through an interface or port.

Antenna 1610, communication interface 1606, and/or processing circuitry 1602 may be configured to perform any receiving operations and/or certain obtaining operations described herein as being performed by the network node. Any information, data and/or signals may be received from a UE, another network node and/or any other network equipment. Similarly, antenna 1610, communication interface 1606, and/or processing circuitry 1602 may be configured to perform any transmitting operations described herein as being performed by the network node. Any information, data and/or signals may be transmitted to a UE, another network node and/or any other network equipment.

Power source 1608 provides power to the various components of network node 1600 in a form suitable for the respective components (e.g., at a voltage and current level needed for each respective component). Power source 1608 may further comprise, or be coupled to, power management circuitry to supply the components of network node 1600 with power for performing the functionality described herein. For example, network node 1600 may be connectable to an external power source (e.g., the power grid, an electricity outlet) via an input circuitry or interface such as an electrical cable, whereby the external power source supplies power to power circuitry of power source 1608. As a further example, power source 1608 may comprise a source of power in the form of a battery or battery pack which is connected to, or integrated in, power circuitry. The battery may provide backup power should the external power source fail.

Embodiments of network node 1600 may include additional components beyond those shown in FIG. 16 for providing certain aspects of the network node's functionality, including any of the functionality described herein and/or any functionality necessary to support the subject matter described herein. For example, network node 1600 may include user interface equipment to allow input of information into network node 1600 and to allow output of information from network node 1600. This may allow a user to perform diagnostic, maintenance, repair, and other administrative functions for network node 1600.

FIG. 17 is a block diagram of a host 1700, which may be an embodiment of host 1416 of FIG. 14, in accordance with various aspects described herein. As used herein, host 1700 may be or comprise various combinations hardware and/or software, including a standalone server, a blade server, a cloud-implemented server, a distributed server, a virtual machine, container, or processing resources in a server farm. Host 1700 may provide one or more services to one or more UEs.

Host 1700 includes processing circuitry 1702 that is operatively coupled via bus 1704 to input/output interface 1706, network interface 1708, power source 1710, and memory 1712. Other components may be included in other embodiments. Features of these components may be substantially similar to those described with respect to the devices of previous figures, such as FIGS. 15 and 16, such that the descriptions thereof are generally applicable to the corresponding components of host 1700.

Memory 1712 may include one or more computer programs including one or more host application programs 1714 and data 1716, which may include user data, e.g., data generated by a UE for host 1700 or data generated by host 1700 for a UE. Embodiments of host 1700 may utilize only a subset or all of the components shown. Host application programs 1714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1714 may also provide for user authentication and licensing checks and may periodically report health, routes, and content availability to a central node, such as a device in or on the edge of a core network. Accordingly, host 1700 may select and/or indicate a different host for over-the-top services for a UE. Host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1800 includes components defined by the O-RAN Alliance, such as an O-Cloud environment orchestrated by a Service Management and Orchestration Framework via an O-2 interface.

Applications 1802 (which may alternatively be called software instances, virtual appliances, network functions, virtual nodes, virtual network functions, etc.) are run in the virtualization environment 1800 to implement some of the features, functions, and/or benefits of some of the embodiments disclosed herein.

Hardware 1804 includes processing circuitry, memory that stores software and/or instructions (collected denoted computer program 1804a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a-b (one or more of which may be generally referred to as VMs 1808), and/or perform any of the functions, features and/or benefits described in relation with some embodiments described herein. Virtualization layer 1806 may present a virtual operating platform that appears like networking hardware to the VMs 1808.

VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1808 may be a software implementation of a physical machine that runs programs as if they were executing on a physical, non-virtualized machine. Each VM 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of hardware 1804 and corresponds to application 1802.

Hardware 1804 may be implemented in a standalone network node with generic or specific components. Hardware 1804 may implement some functions via virtualization. Alternatively, hardware 1804 may be part of a larger cluster of hardware (e.g., such as in a data center or CPE) where many hardware nodes work together and are managed via management and orchestration function 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

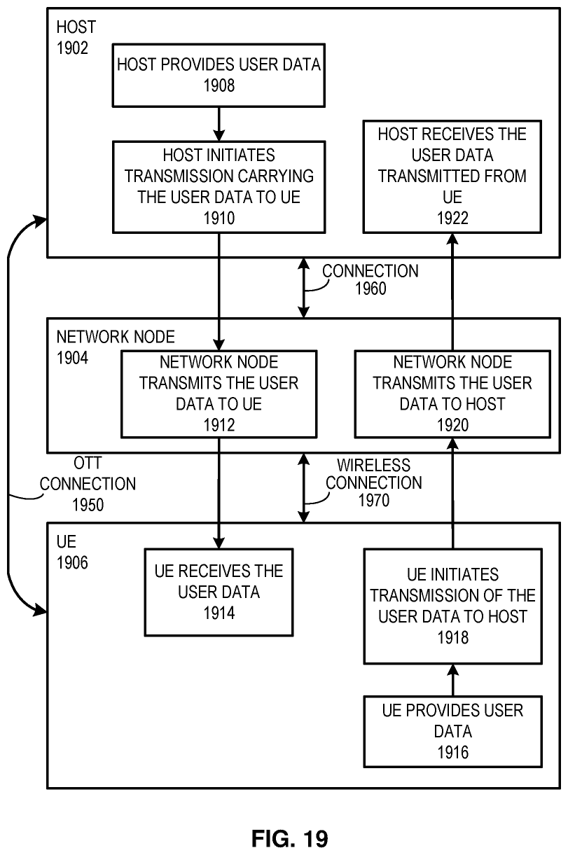

FIG. 19 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 14 and/or UE 1500 of FIG. 15), network node (such as network node 1410a of FIG. 14 and/or network node 1600 of FIG. 16), and host (such as host 1416 of FIG. 14 and/or host 1700 of FIG. 17) discussed in the preceding paragraphs will now be described with reference to FIG. 19.

Like host 1700, embodiments of host 1902 include hardware, such as a communication interface, processing circuitry, and memory. Host 1902 also includes software, which is stored in or accessible by host 1902 and executable by the processing circuitry. The software includes a host application that may be operable to provide a service to a remote user, such as UE 1906 connecting via an over-the-top (OTT) connection 1950 extending between UE 1906 and host 1902. In providing the service to the remote user, a host application may provide user data which is transmitted using OTT connection 1950.

Network node 1904 includes hardware enabling it to communicate with host 1902 and UE 1906. Connection 1960 may be direct or pass through a core network (like core network 1406 of FIG. 14) and/or one or more other intermediate networks, such as one or more public, private, or hosted networks. For example, an intermediate network may be a backbone network or the Internet.

UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of host 1902. In host 1902, an executing host application may communicate with the executing client application via OTT connection 1950 terminating at UE 1906 and host 1902. In providing the service to the user, the UE's client application may receive request data from the host's host application and provide user data in response to the request data. OTT connection 1950 may transfer both the request data and the user data. The UE's client application may interact with the user to generate the user data that it provides to the host application through OTT connection 1950.

OTT connection 1950 may extend via a connection 1960 between host 1902 and network node 1904 and via a wireless connection 1970 between network node 1904 and UE 1906 to provide the connection between host 1902 and UE 1906. Connection 1960 and wireless connection 1970, over which OTT connection 1950 may be provided, have been drawn abstractly to illustrate the communication between host 1902 and UE 1906 via network node 1904, without explicit reference to any intermediary devices and the precise routing of messages via these devices.

As an example of transmitting data via OTT connection 1950, in step 1908, host 1902 provides user data, which may be performed by executing a host application. In some embodiments, the user data is associated with a particular human user interacting with UE 1906. In other embodiments, the user data is associated with a UE 1906 that shares data with host 1902 without explicit human interaction. In step 1910, host 1902 initiates a transmission carrying the user data towards UE 1906. Host 1902 may initiate the transmission responsive to a request transmitted by UE 1906. The request may be caused by human interaction with UE 1906 or by operation of the client application executing on UE 1906. The transmission may pass via network node 1904, in accordance with the teachings of the embodiments described throughout this disclosure. Accordingly, in step 1912, network node 1904 transmits to UE 1906 the user data that was carried in the transmission that host 1902 initiated, in accordance with the teachings of the embodiments described throughout this disclosure. In step 1914, UE 1906 receives the user data carried in the transmission, which may be performed by a client application executed on UE 1906 associated with the host application executed by host 1902.

In some examples, UE 1906 executes a client application which provides user data to host 1902. The user data may be provided in reaction or response to the data received from host 1902. Accordingly, in step 1916, UE 1906 may provide user data, which may be performed by executing the client application. In providing the user data, the client application may further consider user input received from the user via an input/output interface of UE 1906. Regardless of the specific manner in which the user data was provided, UE 1906 initiates, in step 1918, transmission of the user data towards host 1902 via network node 1904. In step 1920, in accordance with the teachings of the embodiments described throughout this disclosure, network node 1904 receives user data from UE 1906 and initiates transmission of the received user data towards host 1902. In step 1922, host 1902 receives the user data carried in the transmission initiated by UE 1906.

One or more of the various embodiments improve the performance of OTT services provided to UE 1906 using OTT connection 1950, in which wireless connection 1970 forms the last segment. More precisely, embodiments may facilitate correct operation of L3 mobility when LTM is also configured for a UE by releasing LTM configurations that are not applicable after an L3 mobility procedure, such as intra-CU LTM configuration(s) that are not applicable after an inter-CU L3 mobility procedure. Embodiments may also facilitate configuration of LTM for a UE during configuration or execution of an L3 mobility procedure, such as a target RAN node providing LTM configuration(s) that are applicable after the UE completes the L3 mobility procedure. Furthermore, embodiments may improve UE mobility in RANs (e.g., NG-RANs) by facilitating interoperability of L3 mobility and LTM. By improving operation of UEs and RANs in this manner, embodiments may increase the value of OTT services delivered to/from the UE via the RAN.

In an example scenario, factory status information may be collected and analyzed by host 1902. As another example, host 1902 may process audio and video data which may have been retrieved from a UE for use in creating maps. As another example, host 1902 may collect and analyze real-time data to assist in controlling vehicle congestion (e.g., controlling traffic lights). As another example, host 1902 may store surveillance video uploaded by a UE. As another example, host 1902 may store or control access to media content such as video, audio, VR or AR which it can broadcast, multicast or unicast to UEs. As other examples, host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1950 between host 1902 and UE 1906, in response to variations in the measurement results. The measurement procedure and/or the network functionality for reconfiguring the OTT connection may be implemented in software and hardware of host 1902 and/or UE 1906. In some embodiments, sensors (not shown) may be deployed in or in association with other devices through which OTT connection 1950 passes; the sensors may participate in the measurement procedure by supplying values of the monitored quantities exemplified above, or supplying values of other physical quantities from which software may compute or estimate the monitored quantities. Reconfiguring OTT connection 1950 may include message format, retransmission settings, preferred routing etc.; the reconfiguring need not directly alter the operation of network node 1904. Such procedures and functionalities may be known and practiced in the art. In certain embodiments, measurements may involve proprietary UE signaling that facilitates measurements of throughput, propagation times, latency and the like, by host 1902. The measurements may be implemented in that software causes messages to be transmitted, in particular empty or ‘dummy’ messages, using OTT connection 1950 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for performing one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Furthermore, functions described herein as being performed by a wireless device or a network node may be distributed over a plurality of wireless devices and/or network nodes. In other words, it is contemplated that the functions of a network node and a wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:
A1. A method for a user equipment (UE) configured to perform a layer-3 (L3) mobility procedure in a radio access network (RAN), the method comprising:
   receiving, via a source cell in the RAN, a configuration for a layer-1 (L2) or layer-2 (L2) triggered inter-cell mobility (LTM) procedure in the RAN;
   managing the LTM configuration in relation to an L3 mobility procedure that involves a target cell in the RAN, including one or more of the following management operations:
      maintaining the LTM configuration;
      releasing the LTM configuration;
      modifying the LTM configuration; and
      adding a second LTM configuration.
A2. The method of embodiment A1, wherein managing the LTM configuration is performed upon or during execution of the L3 mobility procedure.
A3. The method of embodiment A2, wherein managing the LTM configuration is based on whether the target cell for the L3 mobility procedure is provided by a different RAN node than the source cell.
A3a. The method of embodiment A3, wherein managing the LTM configuration comprises:
   releasing the LTM configuration when the target cell is provided by a different RAN node than the source cell; and
   maintaining the LTM configuration when the target cell is provided by a same RAN node as the source cell.
A4. The method of any of embodiments A1-A2, further comprising receiving from the RAN an indication of one or more of the management operations to be performed, wherein managing the LTM configuration is responsive to the indication.
A4a. The method of embodiment A4, wherein the indication is received in one of the following:
   an L3 message via the source cell or the target cell;
   an L2 message via the source cell or the target cell;
   an L1 message via the source cell.
A4b. The method of embodiment A4a, wherein the indication in one of the following data structures of the L3 message: ToAddMod, ToRelease, or SetupRelease.
A4c. The method of any of embodiments A4-A4b, wherein the L3 mobility procedure is a non-conditional mobility procedure and the indication is received in or with a command to perform the non-conditional mobility procedure.
A4d. The method of any of embodiments A4-A4b, wherein the L3 mobility procedure is a conditional mobility procedure and the indication is received in or with a conditional configuration for the conditional mobility procedure.
A4e. The method of any of embodiments A4-A4d, wherein the indication includes one or more of the following:
   an indication to release the LTM configuration;
   a second LTM configuration to be added;
   an indication of a part of the LTM configuration to be released or modified; and
   information to be added to the LTM configuration.
A4f. The method of embodiment A4e, wherein one or more of the following applies:
   the indicated part of the LTM configuration to be released or modified includes one or more LTM candidate cell configurations; and
   the information to be added includes one or more LTM candidate cell configurations.
A4g. The method of any of embodiments A4-A4f, further comprising sending to the RAN a confirmation or acknowledgement that the indicated management operations have been performed.
A5. The method of any of embodiments A1-A4g, wherein the LTM configuration includes one or more of the following:
   one or more LTM candidate cell configurations;
   measurement and reporting configuration for LTM candidate cells;
   downlink (DL) pre-synchronization configuration for LTM;
   uplink (UL) pre-synchronization configuration for LTM; and
   execution configurations for LTM cell switch procedures to respective LTM candidate cells.
A5a. The method of embodiment A5, wherein modifying the LTM configuration comprises one or more of the following:
   releasing one of a plurality of LTM candidate cell configurations while maintaining other of the plurality of the LTM candidate cell configurations; and
   adding a further LTM candidate cell configuration to the LTM candidate cell configurations.
A6. The method of any of embodiments A1-A5a, wherein the L3 mobility procedure is one of the following: handover, dual active protocol stack (DAPS) handover reconfiguration with sync, conditional handover, conditional reconfiguration, primary SCG cell (PSCell) change, conditional PSCell change, conditional PSCell addition, secondary node (SN) change, SN modification, master node (MN) change.
B1. A method for a radio access network (RAN) node configured to provide a source cell for user equipment (UE) layer-3 (L3) mobility procedures, the method comprising:
   sending, to a UE via the source cell, a configuration for a layer-1 (L2) or layer-2 (L2) triggered inter-cell mobility (LTM) procedure in the RAN; and
   managing the LTM configuration in relation to an L3 mobility procedure for the UE that involves a target cell in the RAN, including one or more of the following management operations:
      maintaining the LTM configuration;
      releasing the LTM configuration;
      modifying the LTM configuration; and
      adding a second LTM configuration.
B2. The method of embodiment B1, wherein managing the LTM configuration is performed upon or during execution of the L3 mobility procedure.
B3. The method of embodiment B2, wherein managing the LTM configuration is based on whether the target cell for the L3 mobility procedure is provided by another RAN node.
B3a. The method of embodiment B3, wherein managing the LTM configuration comprises:
   releasing the LTM configuration when the target cell is provided by another RAN node; and
   maintaining the LTM configuration when the target cell is provided by the RAN node.
B4. The method of any of embodiments B1-B2, further comprising sending to the UE an indication of one or more corresponding management operations to be performed by the UE on the LTM configuration.
B4a. The method of embodiment B4, wherein the indication is sent to the UE in one of the following via the source cell: an L3 message, an L2 message, or an L1 message.
B4b. The method of embodiment B4a, wherein the indication is in one of the following data structures of the L3 message: ToAddMod, ToRelease, or SetupRelease.
B4c. The method of any of embodiments B4-B4b, wherein L3 mobility procedure is a non-conditional mobility procedure and the indication is sent to the UE in or with a command to perform the non-conditional mobility procedure.
B4d. The method of any of embodiments B4-B4b, wherein L3 mobility procedure is a conditional mobility procedure and the indication is sent to the UE in or with a conditional configuration for the conditional mobility procedure.
B4e. The method of any of embodiments B4-B4d, wherein the indication sent to the UE includes one or more of the following:
   an indication to release the LTM configuration;
   a second LTM configuration to be added;
   an indication of a part of the LTM configuration to be released or modified; and
   information to be added to the LTM configuration.
B4f. The method of embodiment B4e, wherein one or more of the following applies:
   the indicated part of the LTM configuration to be released or modified includes one or more LTM candidate cell configurations; and
   the information to be added includes one or more LTM candidate cell configurations.
B4g. The method of any of embodiments B4-B4f, further comprising receiving from the UE a confirmation or acknowledgement that the corresponding management operations have been performed.
B5. The method of any of embodiments B1-B4g, wherein the LTM configuration includes one or more of the following:
   one or more LTM candidate cell configurations;
   measurement and reporting configuration for LTM candidate cells;
   downlink (DL) pre-synchronization configuration for LTM;
   uplink (UL) pre-synchronization configuration for LTM; and
   execution configurations for LTM cell switch procedures to respective LTM candidate cells.
B5a. The method of embodiment B5, wherein modifying the LTM configuration comprises one or more of the following:
   releasing one of a plurality of LTM candidate cell configurations while maintaining other of the plurality of the LTM candidate cell configurations; and
   adding a further LTM candidate cell configuration to the LTM candidate cell configurations.
B6. The method of any of embodiments B1-B5a, further comprising:
   sending, to a target RAN node that provides the target cell, a request to perform the L3 mobility procedure for the UE; and
   receiving the following from the target RAN node: a configuration for the L3 mobility procedure for the UE, and an indication of the one or more management operations to be performed on the LTM configuration.
B6a. The method of embodiment B6, wherein the request to perform the L3 mobility procedure includes at least part of the LTM configuration.
B6b. The method of any of embodiments B6-B6a, wherein the indication from the target RAN node includes one or more of the following:
   an indication that the target RAN node does not support LTM;
   an indication to release the LTM configuration;
   a second LTM configuration to be added;
   an indication of a part of the LTM configuration to be released or modified; and
   information to be added to the LTM configuration.
B6c. The method of embodiment B6b, wherein one or more of the following applies:
   the indicated part of the LTM configuration to be released or modified includes one or more LTM candidate cell configurations; and
   the information to be added includes one or more LTM candidate cell configurations.
B7. The method of any of embodiments B1-B6c, wherein the L3 mobility procedure is one of the following: handover, dual active protocol stack (DAPS) handover reconfiguration with sync, conditional handover, conditional reconfiguration, primary SCG cell (PSCell) change, conditional PSCell change, conditional PSCell addition, secondary node (SN) change, SN modification, master node (MN) change.
C1. A method for a radio access network (RAN) node configured to provide a target cell for user equipment (UE) layer-3 (L3) mobility procedures, the method comprising:
   in relation to an L3 mobility procedure for a UE that involves the target cell, managing a configuration for a layer-1 (L2) or layer-2 (L2) triggered inter-cell mobility (LTM) procedure for the UE that involves a source cell in the RAN, including one or more of the following management operations:
      maintaining the LTM configuration;
      releasing the LTM configuration;
      modifying the LTM configuration; and
      adding a second LTM configuration.
C2. The method of embodiment C1, wherein managing the LTM configuration is performed upon or during execution of the L3 mobility procedure.
C3. The method of embodiment C2, wherein managing the LTM configuration is based on whether the source cell is provided by another RAN node.
C3a. The method of embodiment C3, wherein managing the LTM configuration comprises:
   releasing the LTM configuration when the source cell is provided by another RAN node; and
   maintaining the LTM configuration when the source cell is provided by the RAN node.
C4. The method of any of embodiments B1-B2, further comprising sending to the UE an indication of one or more corresponding management operations to be performed by the UE on the LTM configuration.
C4a. The method of embodiment C4, wherein the indication is sent to the UE via the target cell in an L3 message or in an L2 message.
C4b. The method of embodiment C4a, wherein the indication is in one of the following data structures of the L3 message: ToAddMod, ToRelease, or SetupRelease.
C4c. The method of any of embodiments C4-C4b, wherein the indication sent to the UE includes one or more of the following:
   an indication that the target RAN node does not support LTM;
   an indication to release the LTM configuration;
   a second LTM configuration to be added;
   an indication of a part of the LTM configuration to be released or modified; and
   information to be added to the LTM configuration.
C4d. The method of embodiment C4c, wherein one or more of the following applies:
   the indicated part of the LTM configuration to be released or modified includes one or more LTM candidate cell configurations; and
   the information to be added includes one or more LTM candidate cell configurations.
C4e. The method of any of embodiments C4-C4d, further comprising receiving from the UE a confirmation or acknowledgement that the corresponding management operations have been performed.
C5. The method of any of embodiments C1-C4e, wherein the LTM configuration includes one or more of the following:
   one or more LTM candidate cell configurations;
   measurement and reporting configuration for LTM candidate cells;
   downlink (DL) pre-synchronization configuration for LTM;
   uplink (UL) pre-synchronization configuration for LTM; and
   execution configurations for LTM cell switch procedures to respective LTM candidate cells.
C5a. The method of embodiment C5, wherein modifying the LTM configuration comprises one or more of the following:
   releasing one of a plurality of LTM candidate cell configurations while maintaining other of the plurality of the LTM candidate cell configurations; and
   adding a further LTM candidate cell configuration to the LTM candidate cell configurations.
C6. The method of any of embodiments C1-C5a, further comprising:
   receiving, from a source RAN node that provides the source cell, a request to perform the L3 mobility procedure for the UE; and
   receiving the following from the target RAN node: a configuration for the L3 mobility procedure for the UE, and an indication of the one or more management operations to be performed on the LTM configuration.
C6a. The method of embodiment C6, wherein the request to perform the L3 mobility procedure includes at least part of the LTM configuration.
C6b. The method of any of embodiments C6-C6a, wherein the indication sent to the source RAN node includes one or more of the following:
   an indication that the target RAN node does not support LTM;
   an indication to release the LTM configuration;
   a second LTM configuration to be added;
   an indication of a part of the LTM configuration to be released or modified; and
   information to be added to the LTM configuration.
C6c. The method of embodiment C6b, wherein one or more of the following applies:
   the indicated part of the LTM configuration to be released or modified includes one or more LTM candidate cell configurations; and
   the information to be added includes one or more LTM candidate cell configurations.
C7. The method of any of embodiments C1-C6c, wherein the L3 mobility procedure is one of the following: handover, dual active protocol stack (DAPS) handover reconfiguration with sync, conditional handover, conditional reconfiguration, primary SCG cell (PSCell) change, conditional PSCell change, conditional PSCell addition, secondary node (SN) change, SN modification, master node (MN) change.
D1. A user equipment (UE) configured to perform a layer-3 (L3) mobility procedure from a source cell to a target cell in a radio access network (RAN), the UE comprising:
   communication interface circuitry configured to communicate with the source cell and the target cell; and
   processing circuitry operably coupled to the communication interface circuitry, wherein the processing circuitry and communication interface circuitry are further configured to perform operations corresponding to any of the methods of embodiments A1-A7.
D2. A user equipment (UE) configured to perform a layer-3 (L3) mobility procedure from a source cell to a target cell in a radio access network (RAN), the UE being further configured to perform operations corresponding to any of the methods of embodiments A1-A7.
D3. A non-transitory, computer-readable medium storing computer-executable instructions that, when executed by processing circuitry of a user equipment (UE) configured to perform a layer-3 (L3) mobility procedure from a source cell to a target cell in a radio access network (RAN), configure the UE to perform operations corresponding to any of the methods of embodiments A1-A7.
D4. A computer program product comprising computer-executable instructions that, when executed by processing circuitry of a user equipment (UE) configured to perform a layer-3 (L3) mobility procedure from a source cell to a target cell in a radio access network (RAN), configure the UE to perform operations corresponding to any of the methods of embodiments A1-A7.
E1. A radio access network (RAN) node configured to provide a source cell for user equipment (UE) layer-3 (L3) mobility procedures, the RAN node comprising:
   communication interface circuitry configured to communicate with UEs via the source cell and with a target RAN node configured to provide a target cell for UE L3 mobility procedures; and
   processing circuitry operably coupled to the communication interface circuitry, whereby the processing circuitry and the communication interface circuitry are configured to perform operations corresponding to any of the methods of embodiments B1-B7.
E2. A radio access network (RAN) node configured to provide a source cell for user equipment (UE) layer-3 (L3) mobility procedures, the RAN node being further configured to perform operations corresponding to any of the methods of embodiments B1-B7.
E3. A non-transitory, computer-readable medium storing computer-executable instructions that, when executed by processing circuitry of a radio access network (RAN) node configured to provide a source cell for user equipment (UE) layer-3 (L3) mobility procedures, configure the RAN node to perform operations corresponding to any of the methods of embodiments B1-B7.
E4. A computer program product comprising computer-executable instructions that, when executed by processing circuitry of a radio access network (RAN) node configured to provide a source cell for user equipment (UE) layer-3 (L3) mobility procedures, configure the RAN node to perform operations corresponding to any of the methods of embodiments B1-B7.
F1. A radio access network (RAN) node configured to provide a target cell for user equipment (UE) layer-3 (L3) mobility procedures, the RAN node comprising:
   communication interface circuitry configured to communicate with UEs via the target cell and with a source RAN node configured to provide a source cell for UE L3 mobility procedures; and
   processing circuitry operably coupled to the communication interface circuitry, whereby the processing circuitry and the communication interface circuitry are configured to perform operations corresponding to any of the methods of embodiments C1-C7.
F2. A radio access network (RAN) node configured to provide a target cell for user equipment (UE) layer-3 (L3) mobility procedures, the RAN node being further configured to perform operations corresponding to any of the methods of embodiments C1-C7.
F3. A non-transitory, computer-readable medium storing computer-executable instructions that, when executed by processing circuitry of a radio access network (RAN) node configured to provide a target cell for user equipment (UE) layer-3 (L3) mobility procedures, configure the RAN node to perform operations corresponding to any of the methods of embodiments C1-C7.
F4. A computer program product comprising computer-executable instructions that, when executed by processing circuitry of a radio access network (RAN) node configured to provide a target cell for user equipment (UE) layer-3 (L3) mobility procedures, configure the RAN node to perform operations corresponding to any of the methods of embodiments C1-C7.

1.-46. (canceled)

47. A method for a user equipment (UE) configured to perform a layer-3 (L3) mobility procedure in a radio access network (RAN) the method comprising:
receiving, via a source cell in the RAN, a configuration for a layer-1 or layer-2 triggered inter-cell mobility (LTM) procedure in the RAN;
receiving an L3 mobility command that includes an indication to perform one or more of the following management operations:
modifying the LTM configuration; and
adding a second LTM configuration,
managing the LTM configuration during execution of an L3 mobility procedure to a target cell in the RAN, including performing the indicated one or more management operations.

48. The method of claim 47, wherein the L3 mobility procedure is a conditional mobility procedure and the indication is received in or with a conditional configuration for the conditional mobility procedure.

49. The method of claim 47, wherein the indication also indicates one or more of the following:
to release the LTM configuration;
a second LTM configuration to be added;
a part of the LTM configuration, including one or more LTM candidate cell configurations, to be released or modified; and
one or more further LTM candidate cell configurations to be added to the LTM configuration.

50. The method of claim 47, further comprising sending to the RAN a confirmation or acknowledgement that the indicated one or more management operations have been performed.

51. The method of claim 47, wherein the L3 mobility procedure is one of the following: handover; reconfiguration with sync; conditional handover; conditional reconfiguration; primary SCG cell (PSCell) change; conditional PSCell change; conditional PSCell addition; secondary node (SN)) change; SN modification; and master node (MN) change.

52. A method for a radio access network (RAN) node configured to provide a target cell for user equipment (UE) layer-3 (L3) mobility procedures, the method comprising:
during execution of an L3 mobility procedure for a UE to the target cell, managing a configuration for a layer-1 or layer-2 triggered inter-cell mobility (LTM) procedure for the UE from a source cell in the RAN, including performing one or more of the following management operations:
modifying the LTM configuration, and
adding a second LTM configuration; and
sending, to the UE via the target cell, an L3 mobility command that includes an indication of one or more corresponding management operations to be performed by the UE on the LTM configuration.

53. The method of claim 52, wherein the indication sent to the UE also indicates one or more of the following:
that the target RAN node does not support LTM;
to release the LTM configuration;
a second LTM configuration to be added;
an indication of a part of the LTM configuration, including one or more LTM candidate-cell configurations, to be released or modified; and
one or more further LTM candidate-cell configurations to be added to the LTM configuration.

54. The method of claim 52, wherein L3 mobility procedure is a conditional mobility procedure and the indication is sent to the UE in or with a conditional configuration for the conditional mobility procedure.

55. The method of claim 52, further comprising receiving from the UE a confirmation or acknowledgement that the corresponding one or more management operations have been performed.

56. The method of claim 52, further comprising:
receiving, from a source RAN node that provides the source cell, a request to perform the L3 mobility procedure for the UE; and
sending the following to the source RAN node: a configuration for the L3 mobility procedure for the UE, and an indication to release at least a portion of the LTM configuration.

57. The method of claim 52, wherein the L3 mobility procedure is one of the following: handover; reconfiguration with sync; conditional handover; conditional reconfiguration; primary SCG cell (PSCell) change; conditional PSCell change; conditional PSCell addition; secondary node (SN)) change; SN modification; and master node (MN) change.

58. User equipment (UE) configured to perform a layer-3 (L3) mobility procedure from a source cell to a target cell in a radio access network (RAN), the UE comprising:
communication interface circuitry configured to communicate with the source cell and the target cell; and
processing circuitry operably coupled to the communication interface circuitry, wherein the processing circuitry and communication interface circuitry are configured to:
receive, via the source cell, a configuration for a layer-1 or layer-2 triggered inter-cell mobility (LTM) procedure in the RAN; and
receive an L3 mobility command that includes an indication to perform one or more of the following management operations:
modifying the LTM configuration, and
adding a second LTM configuration; and
manage the LTM configuration during execution of an L3 mobility procedure to a target cell in the RAN, based on an indication received in an L3 mobility command, including performing the indicated one or more management operations.

59. The UE of claim 58, wherein the indication also indicates one or more of the following:
to release the LTM configuration;
a second LTM configuration to be added;
a part of the LTM configuration, including one or more LTM candidate cell configurations, to be released or modified; and
one or more further LTM candidate cell configurations to be added to the LTM configuration.

60. The UE of claim 58, wherein L3 mobility procedure is a conditional mobility procedure and the indication is received in or with a conditional configuration for the conditional mobility procedure.

61. The UE of claim 58, wherein the L3 mobility procedure is one of the following: handover; reconfiguration with sync; conditional handover; conditional reconfiguration; primary SCG cell (PSCell) change; conditional PSCell change; conditional PSCell addition; secondary node (SN)) change; SN modification; and master node (MN) change.

62. Radio access network (RAN) node configured to provide a target cell for user equipment (UE) layer-3 (L3) mobility procedures, the RAN node comprising:
communication interface circuitry configured to communicate with UEs via the target cell and with a source RAN node configured to provide a source cell for UE L3 mobility procedures; and
processing circuitry operably coupled to the communication interface circuitry, wherein the processing circuitry and the communication interface circuitry are configured to:
during execution of an L3 mobility procedure for a UE to the target cell, manage a configuration for a layer-1 or layer-2 triggered inter-cell mobility (LTM) procedure for the UE from a source cell in the RAN, including performing one or more of the following management operations:
modifying the LTM configuration, and
adding a second LTM configuration; and
send, to the UE via the target cell, an L3 mobility command that includes an indication of one or more corresponding management operations to be performed by the UE on the LTM configuration.

63. The RAN node of claim 62, wherein the indication sent to the UE also indicates one or more of the following:
that the target RAN node does not support LTM;
to release the LTM configuration;
a second LTM configuration to be added;
an indication of a part of the LTM configuration, including one or more LTM candidate-cell configurations, to be released or modified; and
one or more further LTM candidate-cell configurations to be added to the LTM configuration.

64. The RAN node of claim 62, wherein L3 mobility procedure is a conditional mobility procedure and the indication is sent to the UE in or with a conditional configuration for the conditional mobility procedure.

65. The RAN node of claim 62, wherein the processing circuitry and the communication interface circuitry are further configured to:
receive, from a source RAN node that provides the source cell, a request to perform the L3 mobility procedure for the UE; and
send the following to the source RAN node: a configuration for the L3 mobility procedure for the UE, and an indication to release at least a portion of the LTM configuration.

66. The RAN node of claim 62, wherein the L3 mobility procedure is one of the following: handover; reconfiguration with sync; conditional handover; conditional reconfiguration; primary SCG cell (PSCell) change; conditional PSCell change; conditional PSCell addition; secondary node (SN)) change; SN modification; and master node (MN) change.
